(19) United States
(12) Patent Application Publication
(10) Pub. No.: US 2025/0301375 A1
(43) Pub. Date: Sep. 25, 2025

(54) METHOD AND APPARATUS FOR CONFIGURING DOWNLINK CONTROL CHANNEL IN COMMUNICATION SYSTEM

(71) Applicant: ELECTRONICS AND TELECOMMUNICATIONS RESEARCH INSTITUTE, Daejeon (KR)

(72) Inventor: Eun Young CHOI, Daejeon (KR)

(73) Assignee: ELECTRONICS AND TELECOMMUNICATIONS RESEARCH INSTITUTE, Daejeon (KR)

(21) Appl. No.: 19/086,715

(22) Filed: Mar. 21, 2025

(30) Foreign Application Priority Data
Mar. 21, 2024 (KR) 10-2024-0039418

(51) Int. Cl. H04W 36/00; H04W 72/232

(52) U.S. Cl. CPC H04W 36/00692; H04W 72/232

(57) ABSTRACT

A method of a first communication node may comprise: obtaining control channel element (CCE) aggregation level (AL) information from a second communication node; identifying whether control information is received from the second communication node based on the CCE AL information; and in response to identifying that the control information is received, obtaining the control information, wherein the CCE AL information includes AL information of each of a plurality of CCEs, the AL information indicates a CCE AL, and the AL information is included in the CCE AL information in ascending order of CCE indexes.

### CROSS-REFERENCE TO RELATED APPLICATIONS

This application claims priority to Korean Patent Application No. 10-2024-0039418, filed on Mar. 21, 2024, with the Korean Intellectual Property Office (KIPO), the entire contents of which are hereby incorporated by reference.

### BACKGROUND

### 1. Technical Field

The present disclosure relates to a technique for configuring downlink control channels, and more particularly, to a technique for configuring downlink control channels in a communication system having a wireless backhaul.

### 2. Related Art

In a cellular communication network, a terminal, such as user equipment (UE), can generally transmit and receive data units through a base station. For example, when there is a data unit to be transmitted to a second terminal, a first terminal may generate a message including the data unit to be transmitted to the second terminal and transmit the generated message to a first base station to which it belongs. The first base station may receive the message from the first terminal and determine that the destination of the received message is the second terminal. The first base station may transmit the message to a second base station to which the identified destination, the second terminal, belongs. The second base station may receive the message from the first base station and determine that the destination of the received message is the second terminal. The second base station may transmit the message to the identified destination, the second terminal. The second terminal may receive the message from the second base station and obtain the data unit included in the received message.

Meanwhile, in the communication system, a link connecting a core network and each base station is referred to as a backhaul link. As the base stations utilize an extremely high-frequency band, the number of base stations required has significantly increased compared to the past. When backhaul links connecting the base stations and the core network are established using wired connections, service providers face significant cost burdens. To address this issue, methods of connecting backhaul links wirelessly have been proposed.

Moreover, as the base stations utilize the high frequency band, a larger amount of data can be transmitted at higher speeds between the base station and the terminal. As the amount of data transmitted at higher speeds between the base station and the terminal increases, the data capacity required for backhaul links connecting the core network and the respective base stations also increases.

As the data capacity required for wireless backhaul links increases, the available frequency resources for communication are expanding to the extremely high-frequency bands, such as terahertz (THz) bands, where securing available spectrum resources is more feasible. To provide high-capacity traffic (˜Tbps) using the THz band, wireless backhaul links connecting the core network and receiving base stations are necessary to ensure network scalability in terms of base station deployment and facilitate support for mobile services.

### SUMMARY

The present disclosure for resolving the above-described problems is directed to providing a method and an apparatus for configuring downlink control channels in a communication system.

A method of a first communication node, according to exemplary embodiments of the present disclosure, may comprise: obtaining control channel element (CCE) aggregation level (AL) information from a second communication node; identifying whether control information is received from the second communication node based on the CCE AL information; and in response to identifying that the control information is received, obtaining the control information, wherein the CCE AL information includes AL information of each of a plurality of CCEs, the AL information indicates a CCE AL, and the AL information is included in the CCE AL information in ascending order of CCE indexes.

The first communication node may perform decoding of the control information using one CCE or two or more CCEs having same AL information consecutively within the CCE AL information.

The first communication node may perform decoding of the control information using one CCE, two or more CCEs having same AL information consecutively within the CCE AL information, or two or more CCEs having same AL information non-consecutively within the CCE AL information.

The CCE AL information may be received from the second communication node through a first channel based on first channel configuration information, the first channel configuration information may include information indicating a control channel resource used by the first channel, and the first channel configuration information may be information received from the second communication node or predefined information.

The first communication node may receive first downlink control information (DCI) including the CCE AL information from the second communication node, and the first DCI may be searched in a common search space (CSS).

The first communication node may receive information on a first radio network temporary identifier for identifying the first DCI at a first time from the second communication node, the first communication node may receive the CCE AL information from the second communication node at a second time, and the first time may be a time before the second time.

The AL information may be identified based on information on a phase of each of preconfigured multiple subcarriers.

A method of a second communication node, according to exemplary embodiments of the present disclosure, may comprise: transmitting control channel element (CCE) aggregation level (AL) information to a first communication node; generating control information to be transmitted to the first communication node; and transmitting the control information to the first communication node based on the CCE AL information, wherein the CCE AL information includes AL information of each of a plurality of CCEs, the AL information indicates a CCE AL, and the AL information is included in the CCE AL information in ascending order of CCE indexes.

The second communication node may transmit the control information to the first communication node using one CCE or two or more CCEs having same AL information consecutively within the CCE AL information.

The second communication node may transmit the control information to the first communication node using one CCE, two or more CCEs having same AL information consecutively within the CCE AL information, or two or more CCEs having same AL information non-consecutively within the CCE AL information.

The CCE AL information may be transmitted to the first communication node through a first channel based on first channel configuration information, the first channel configuration information may include information indicating a control channel resource used by the first channel, and the first channel configuration information may be information transmitted to the first communication node or predefined information.

The second communication node may transmit first downlink control information (DCI) including the CCE AL information to the first communication node, and the first DCI may be searched in a common search space (CSS).

The second communication node may transmit information on a first radio network temporary identifier (RNTI) for identifying the first DCI to the first communication node at a first time, the second communication node may transmit the CCE AL information to the first communication node at a second time, and the first time may be a time before the second time.

The AL information may be identified based on information on a phase of each of preconfigured multiple subcarriers.

A first communication node, according to exemplary embodiments of the present disclosure, may comprise: at least one processor, wherein the at least one processor may cause the first communication node to perform: obtaining control channel element (CCE) aggregation level (AL) information from a second communication node; identifying whether control information is received from the second communication node based on the CCE AL information; and in response to identifying that the control information is received, obtaining the control information, wherein the CCE AL information includes AL information of each of a plurality of CCEs, the AL information indicates a CCE AL, and the AL information is included in the CCE AL information in ascending order of CCE indexes.

The first communication node may perform decoding of the control information using one CCE or two or more CCEs having same AL information consecutively within the CCE AL information.

The first communication node may perform decoding of the control information using one CCE, two or more CCEs having same AL information consecutively within the CCE AL information, or two or more CCEs having same AL information non-consecutively within the CCE AL information.

The CCE AL information may be received from the second communication node through a first channel based on first channel configuration information, the first channel configuration information may include information indicating a control channel resource used by the first channel, and the first channel configuration information may be information received from the second communication node or predefined information.

The first communication node may receive first downlink control information (DCI) including the CCE AL information from the second communication node, and the first DCI may be searched in a common search space (CSS).

The first communication node may receive information on a first radio network temporary identifier for identifying the first DCI at a first time from the second communication node, the first communication node may receive the CCE AL information from the second communication node at a second time, and the first time may be a time before the second time.

According to exemplary embodiments of the present disclosure, when configuring a control channel that includes control information for resource scheduling and demodulation, a method and an apparatus to improve resource efficiency and facilitate identification of information on transmission resources of the control channel can be provided. In addition, when configuring a control channel for resource scheduling and demodulation, scheduling flexibility and hardware complexity can be improved.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating an exemplary embodiment for a case where an RNTI is masked onto a CRC added to a DCI in a communication system.

FIG. 4A is a conceptual diagram illustrating a portion of an exemplary embodiment in which CCEs are allocated in a search space according to CCE ALs in a communication system.

FIG. 4B is a conceptual diagram illustrating the remaining portion of the exemplary embodiment in which CCEs are allocated in a search space according to CCE ALs in the communication system.

FIG. 5 is a block diagram illustrating an exemplary embodiment of a control channel transmission device for describing a procedure of processing DCI transmitted in a communication system according to an exemplary embodiment of the present disclosure.

FIG. 6 is a block diagram illustrating an exemplary embodiment of a control channel reception device for describing a procedure of processing a received control channel in a communication system according to an exemplary embodiment of the present disclosure.

FIG. 7A is a conceptual diagram illustrating a portion of an exemplary embodiment for describing overlap of CCE ALs in a search space according to an exemplary embodiment of the present disclosure.

FIG. 7B is a conceptual diagram illustrating the remaining portion of the exemplary embodiment for describing the overlap of CCE ALs in a search space according to an exemplary embodiment of the present disclosure.

FIG. 8 is a conceptual diagram illustrating an exemplary embodiment of a first configuration method for per-CCE AL information transmission according to an exemplary embodiment of the present disclosure.

FIG. 9 is a block diagram illustrating an exemplary embodiment of a method for transmitting per-CCE AL information in the first configuration method for per-CCE AL information transmission according to an exemplary embodiment of the present disclosure.

FIG. 10 is a conceptual diagram illustrating an exemplary embodiment of a method for decoding a control channel using per-CCE AL information according to an exemplary embodiment of the present disclosure.

FIG. 11 is a conceptual diagram illustrating another exemplary embodiment of a method for decoding a control channel using per-CCE AL information according to an exemplary embodiment of the present disclosure.

FIG. 12 is a conceptual diagram illustrating an exemplary embodiment of a method for identifying whether control information is received using per-CCE AL information according to an exemplary embodiment of the present disclosure.

FIG. 13 is a conceptual diagram illustrating an exemplary embodiment of per-CCE AL information in the third configuration method for per-CCE AL information transmission according to an exemplary embodiment of the present disclosure.

FIG. 14 is a conceptual diagram illustrating an exemplary embodiment of a first method for minimizing decoding processing according to an exemplary embodiment of the present disclosure.

FIG. 15 is a conceptual diagram illustrating an exemplary embodiment of a second method for minimizing decoding processing according to an exemplary embodiment of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

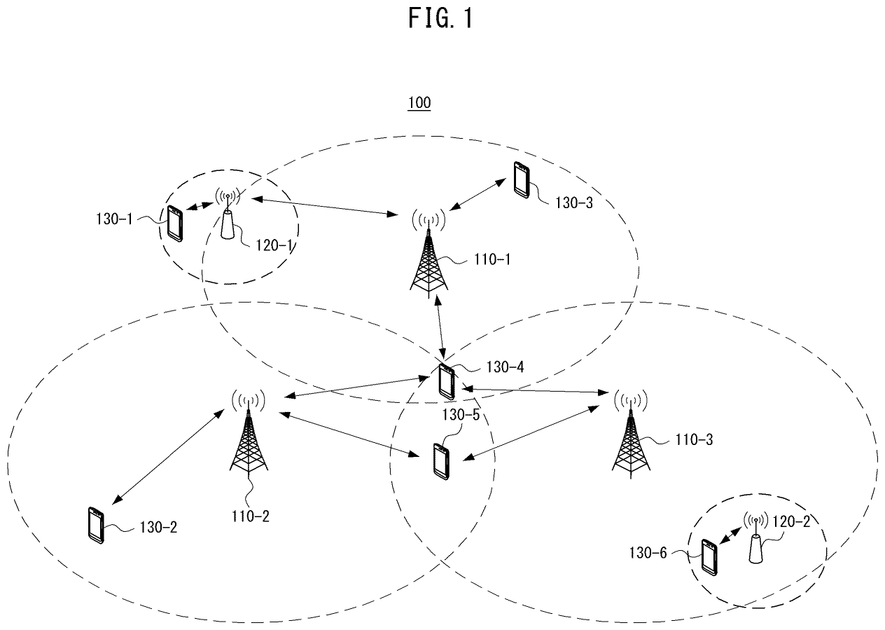

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication (e.g. enhanced version of NR), etc. specified in the 3rd generation partnership project (3GPP) standards. The 4G communication may be performed in frequency bands below 6 GHZ, and the 5G communication may be performed in frequency bands above 6 GHz as well as frequency bands below 6 GHz. The 6G communication can enable data transmission at 1 Tbps in a terahertz band and integrate terrestrial and non-terrestrial communication.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

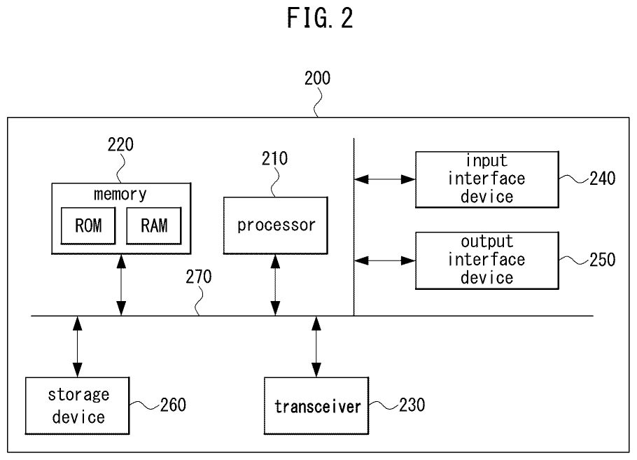

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

In the communication system, as the required data capacity increases, a backhaul link that connects the core network and each base station is expanding to an extremely high frequency band, such as a terahertz (THz) band, where securing available frequency resources within the frequency band used for communication is relatively easy. To provide high-capacity traffic (e.g. at the terabit-per-second (Tbps) level) using the THz band, the backhaul link connecting the core network and the receiving base station may operate wirelessly, thereby ensuring scalability of base station deployment scalability and supporting mobile services. In such a wireless backhaul system, various formats of control information for base station scheduling and demodulation at the downlink transmission side are required to support and ensure the data capacity of the receiving base station within the backhaul link. The size and information content of each format may vary. Such control information may be defined as a downlink control information (DCI) format depending on its intended purpose.

The control information transmitted on a control channel may be configured as data in a DCI format corresponding to the intended purpose within a single DCI, with a maximum size of 140 bits. A cyclic redundancy check (CRC) of 24 bits may be added to the configured payload to determine whether normal decoding can be successfully performed. Additionally, information on a radio network temporary identifier (RNTI) for identifying a receiving terminal or its intended purpose may be masked. Data without RNTI masking may be rearranged through an interleaver. During reception and decoding, the information may be obtained by verifying the RNTI corresponding to the intended purpose. When using the same RNTI, the intended purpose can be identified using an identifier within the DCI or the size of the DCI.

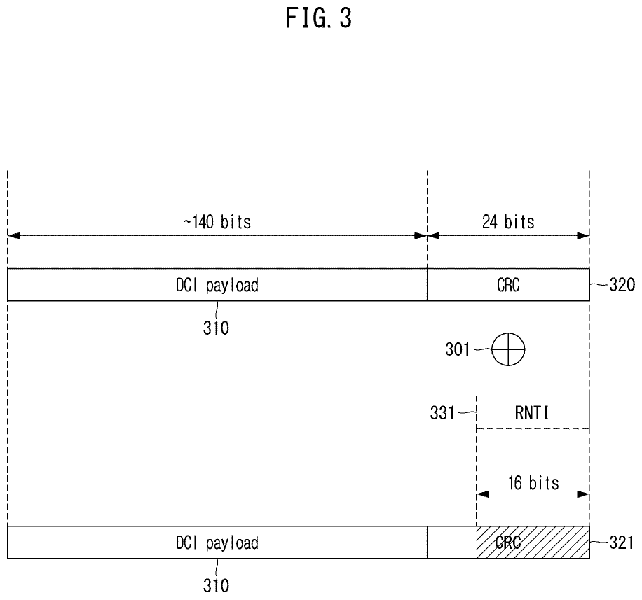

FIG. 3 is a conceptual diagram illustrating an exemplary embodiment for a case where an RNTI is masked onto a CRC added to a DCI in a communication system.

Referring to FIG. 3, an example is shown where a CRC 320 is added to a DCI payload 310. The DCI payload 310 may have a size of 140 bits, and the CRC 320 may be generated based on the DCI payload. The CRC 320 thus generated may have a size of 24 bits. Furthermore, a scrambler 301 may perform scrambling by masking the CRC with a 16-bit RNTI 331 corresponding to the bits of the CRC. Since the CRC 320 has 24 bits and the RNTI has 16 bits, the entire bits of the CRC 320 cannot be masked with the RNTI. Therefore, in the NR communication system, when sequentially masking the RNTI bits onto the CRC bits, the last bit of the RNTI 331 may align with the last bit of the CRC 320. As a result, a portion of the CRC bits may remain unmasked by the RNTI due to the difference between the number of CRC bits and the number of RNTI bits.

In 5G communication (e.g. NR), DCI formats may be defined for scheduling and specific information transmission for a physical downlink shared channel (PDSCH) and a physical uplink shared channel (PUSCH), as shown in Table 1 and Table 2 below. Additionally, for DCI format identification and terminal reception verification in a CRC verification process, RNTI(s) applied to each DCI format may be summarized as illustrated in Table 1 and Table 2.

TABLE 1

| DCI format | Usage | RNTI |
|---|---|---|
| 0_0 | Scheduling of PUSCH in one cell | C-RNTI, CS-RNTI, |
| | | MCS-C-RNTI, TC-RNTI |
| 0_1 | Scheduling of one or multiple PUSCH in one | C-RNTI, CS-RNTI, SP- |
| | cell, or indicating downlink feedback | CSI-RNTI, MCS-C-RNTI |
| | information for configured grant PUSCH (CG- | |
| | DFI) | |
| 0_2 | Scheduling of PUSCH in one cell | C-RNTI, CS-RNTI, SP- |
| | | CSI-RNTI, MCS-C-RNTI |
| 1_0 | Scheduling of PDSCH in one cell | C-RNTI, CS-RNTI, |
| | | MCS-C-RNTI, P-RNTI, |
| | | SI-RNTI, RA-RNTI, |
| | | MsgB-RNTI, TC-RNTI |
| 1_1 | Scheduling of one or multiple PDSCH in one | C-RNTI, CS-RNTI, |
| | cell, and/or triggering one shot HARQ-ACK | MCS-S-RNTI |
| | codebook feedback | |
| 1_2 | Scheduling of PDSCH in one cell | C-RNTI, CS-RNTI, |
| | | MCS-C-RNTI |
| 2_0 | Notifying a group of UEs of the slot format, | SFI-RNTI |
| | available RB sets, COT duration and search | |
| | space set group switching | |
| 2_1 | Notifying a group of UEs of the PRB(s) and | INT-RNTI |
| | OFDM symbol(s) where UE may assume no | |
| | transmission is intended for the UE | |
| 2_2 | Transmission of TPC commands for PUCCH | TPC-PUSCH-RNTI, |
| | and PUSCH | TPC-PUCCH-RNTI |
| 2_3 | Transmission of a group of TPC commands for | TPC-SRS-RNTI |
| | SRS transmissions by one or more UEs | |
| 2_4 | Notifying a group of UEs of the PRB(s) and | CI-RNTI |
| | OFDM symbol(s) where UE cancels the | |
| | corresponding UL transmission from the UE | |

TABLE 2

| DCI | | |
|---|---|---|
| format | Usage | RNTI |
| 2_5 | Notifying the availability of soft resources | AI-RNTI |
| 2_6 | Notifying the power saving information | PS-RNTI |
| | outside DRX Active Time for one or more UEs | |
| 2_7 | Notifying paging early indication and TRS | PEI-RNTI |
| | availability indication for one or more UEs | |
| 3_0 | Scheduling of NR sidelink in one cell | SL-RNTI, |
| | | SL-CS-RNTI |
| 3_1 | Scheduling of LTE sidelink in one cell | V-RNTI |
| 4_0 | Scheduling of PDSCH with CRC scrambled by | MCCH-RNTI, |
| | MCCH-RNTI/G-RNTI for broadcast | G-RNTI |
| 4_1 | Scheduling of PDSCH with CRC scrambled by | G-RNTI, |
| | G-RNTI/G-CS-RNTI for multicast | G-CS-RNTI |
| 4_2 | Scheduling of PDSCH with CRC scrambled by | G-RNTI, |
| | G-RNTI/G-CS-RNTI for multicast | G-CS-RNTI |

Some of the contents of the RNTIs illustrated in Table 1 and Table 2 may be summarized as follows.
SI-RNTI: System Information RNTI
P-RNTI: Paging RNTI
RA-RNTI: Random Access RNTI
TC-RNTI: Temporary Cell RNTI
C-RNTI: Cell RNTI
MCS-C-RNTI: Modulation Coding Scheme-Cell RNTI
CS-RNTI: Configured Scheduling RNTI
TPC-PUCCH-RNTI: Transmit Power Control-PUCCH RNTI
TPC-PUSCH-RNTI: Transmit Power Control-PUSCH RNTI
TPC-SRS-RNTI: Transmit Power Control-Sounding Reference Symbol RNTI
INT-RNTI: Interruption RNTI
SFI-RNTI: Slot Format Indication RNTI
SP-CSI-RNTI: Semi-Persistent CSI RNTI
MCS-C-RNTI: RNTI used to indicate an alternative MCS table for PDSCH and PUSCH
G-RNTI: Group RNTI
PEI-RNTI: Paging Early Indication RNTI
SL-RNTI: Sidelink RNTI
SL-CS-RNTI: Sidelink Configured Scheduling RNTI
PS-RNTI: Power Saving RNTI

According to Table 1 and Table 2, the usage of DCI formats and the RNTIs available for each DCI format may be identified. Additionally, as described in some usages in Table 1, the CRC may be described as being scrambled with a specific RNTI. In the present disclosure, scrambling of a CRC with an RNTI may be understood as the same form as the masking of the CRC with the RNTI. Therefore, in the present disclosure, the descriptions of CRC scrambling with an RNTI and CRC masking with the RNTI, as described below, may be understood as the same.

As shown in Table 1 and Table 2, in 5G communication (e.g. NR), DCI format(s) may be defined and transmitted for purposes other than scheduling, including resource allocation information for PDSCH and PUSCH transmissions, uplink (PUSCH, PUCCH, SRS) power control indication, slot format indication, and PRBs and OFDM symbols of a terminal in which data is not mapped (no transmission). For example, the DCI format 2_2 is a format for transmit power control and may deliver transmit power control (TPC) commands using two-bit information. Additionally, the DCI format 2_2 may include closed-loop indicator information and N block numbers. The DCI format 2_2 may be configured as follows, where N may be a natural number equal to or greater than one.
Block number 1, block number 2, . . . , block number N
Closed-loop indicator (0 or 1 bit)
TPC command (2 bits)

Meanwhile, as the number of DCI formats increases and the sizes of the respective DCI formats vary, a receiving terminal or base station may attempt decoding for each DCI format that needs to decoded, which may increase hardware complexity. To prevent an increase in DCI decoding attempts, the DCI payload sizes for available DCI formats may be adjusted, and the DCI formats with the same size may be configured. When necessary, the DCI sizes may be adjusted to be equal through an appropriate process.

In an exemplary embodiment, the DCI format 0_0 may be monitored in a common search space (CSS). The payload size of DCI format 0_0 may be smaller than the payload size of DCI format 1_0 monitored in the same serving cell. In an exemplary embodiment, padding may be applied to the DCI format 0_0 so that the payload size thereof is the same as that of DCI format 1_0.

In another exemplary embodiment, the DCI format 0_0 may be monitored in a CSS. The payload size of DCI format 0_0 may be larger than the payload size of DCI format 1_0 monitored in the same serving cell. In another exemplary embodiment, truncation may be applied to the DCI format 0_0 to reduce the number of bits for frequency resource allocation within the DCI format 0_0.

DCI formats may be distinguished based on the usage and content of the included information, and even formats with the same usage may have different sizes. In the NR communication system, there may be four different DCI format sizes. When DCI format sizes differ, separate decoding attempts may be made during control channel demodulation. For example, a terminal may monitor three different sizes of DCI formats using a C-RNTI and one DCI format of a specific size that uses a specific RNTI according to the intended purpose.

Resources for control channels may be allocated within a control resource set (CORESET) that has a size and position configured by a network. A CORESET may be allocated anywhere within a slot, spanning one to three consecutive OFDM symbols in the time domain. A CORESET may be allocated with a certain number N_{RB}^{CORESET} of resource blocks (RBs) within a bandwidth part (BWP) in units of 6 RBs in the frequency domain. Up to 4 BWPs may be supported, and up to 3 CORESETs may be configured within a single BWP.

A control channel for control information transmission may be allocated in units of resource element groups (REGs), which are groups of resource elements (REs), within a resource region configured in the communication system (e.g. 5G communication system, 6G communication system). One REG may be configured with REs within one RB, excluding reference signal (RS) REs among 12 REs within the one RB. One control channel element (CCE) may be configured with 6 REGs. CCE-to-REG resource allocation may be performed without interleaving or may be performed in an interleaving manner within a CORESET according to an REG bundling size. The control channel may use quadrature phase shift keying (QPSK) modulation, and one CCE may transmit 108 bits of information in REs excluding demodulation reference signal (DM-RS) REs. The REG bundling size may be 2 or 6, and the overhead caused by RS may be ¼.

In the communication system (e.g. 4G communication system, 5G communication system, 6G communication system), the control channel may configure a DCI according to a usage. The control channel may be transmitted based on physical resource allocation with a CCE aggregation level (AL) ranging from 1 to 16. As the AL increases, resources allocated to the control channel may increase, thereby improving reliability. The size of transmission resources may also vary to enhance the reliability of the control channel and support stable reception in various environments. To this end, a single DCI may be allocated to multiple CCEs and transmitted at a low code rate.

In the NR communication system, as in LTE, the PDCCH may be allocated to a possible CCE position as determined by AL within a CORESET. By arranging CCEs sequentially within the CORESET and applying the CCE AL determined based on factors such as channel conditions, the PDCCH may be allocated at an interval corresponding to the CCE AL. That is, after indexing the CCEs sequentially as 0, 1, 2, . . . , and the like, if the AL is 4, PDCCH allocation may start at the 0th, 4th, 8th, . . . , 4n-th CCE (where n is a non-negative integer) and span 4 consecutive CCEs. Through this process, the PDCCH instances to be transmitted may be mapped to the control channel region.

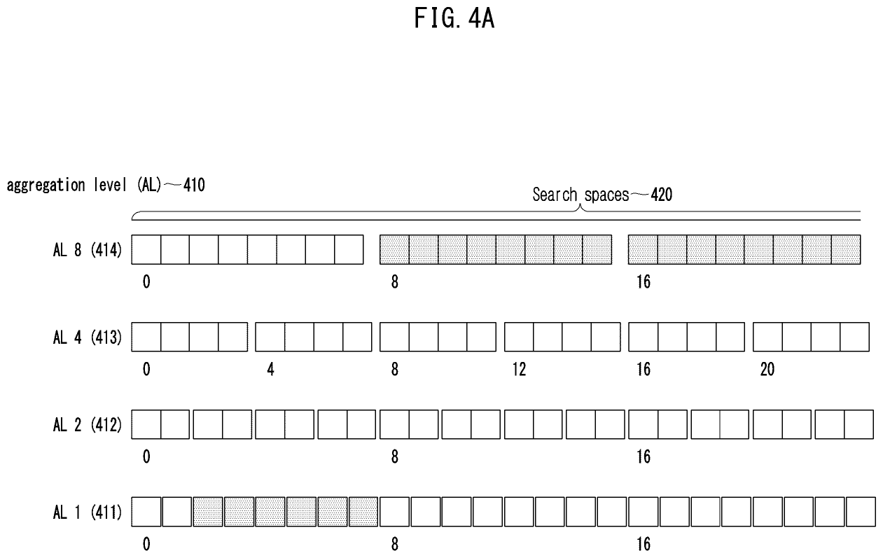

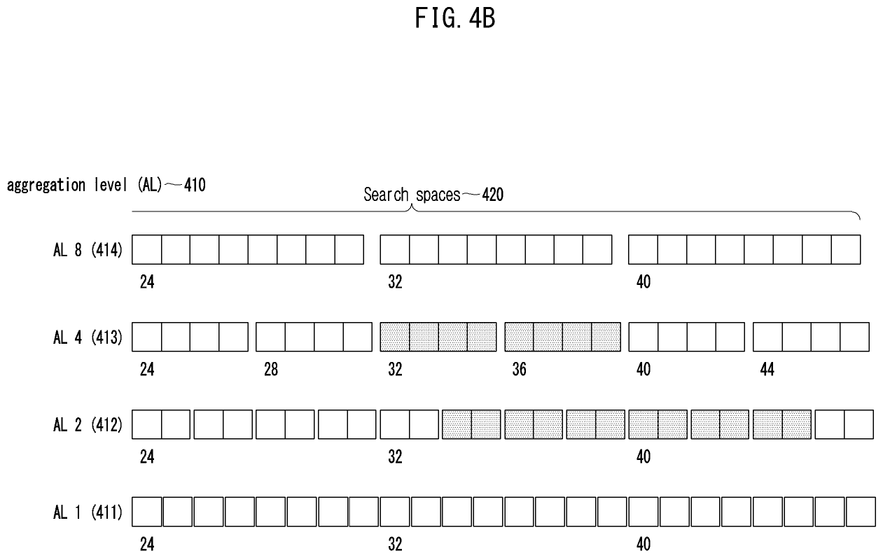

FIG. 4A is a conceptual diagram illustrating a portion of an exemplary embodiment in which CCEs are allocated in a search space according to CCE ALs in a communication system, and FIG. 4B is a conceptual diagram illustrating the remaining portion of the exemplary embodiment in which CCEs are allocated in a search space according to CCE ALs in the communication system.

Referring to FIG. 4A and FIG. 4B, AL 410 may be classified into four levels: AL 1 411, AL 2 412, AL 4 413, and AL 8 414. Additionally, a search space 420 illustrates 48 CCEs, ranging from the 0th CCE to the 47th CCE. The communication system may be a 5G communication system. Alternatively, the communication system may be a 6G communication system.

Generally, a DCI included in a PDCCH having an AL of L may map L sequentially indexed CCEs across multiple REGs within a CORESET. Here, the CCEs may be sequentially indexed as 0, 1, 2, . . . , and the like. If the AL is 4, allocation may start from the 0th, 4th, 8th, . . . , 4n-th CCE and span 4 consecutive CCEs. Through this process, PDCCHs to be transmitted may be allocated to the control channel region.

A receiving node (e.g. terminal) may decode a PDCCH using four UE-specific search space ALs (i.e. AL 1, AL 2, AL 4, and AL 8). In the following description, the receiving node is assumed to include at least one of a UE, or a distributed unit (DU) or a radio unit (RU) according to open radio access network (O-RAN) communication specifications. Additionally, a transmitting node is assumed to include at least one of a base station, or a centralized unit (CU), a DU, and/or an RU according to the O-RAN communication specifications.

Referring to FIG. 4A and FIG. 4B, when decoding is performed by the terminal assuming AL 1, the number of PDCCH candidates may be 6, and the size of CCEs (i.e. the number of CCEs) may be 6. As illustrated in FIG. 4A, decoding may be performed in the search space from index 2 to index 7. When decoding is performed by the terminal assuming AL 2, the number of PDCCH candidates may be 6, and the size of CCEs may be 12. As illustrated in FIG. 4B, decoding may be performed in the search space from index 34 to index 45. Additionally, when assuming AL 4, the number of PDCCH candidates may be 2, and the size of CCEs may be 4. As illustrated in FIG. 4B, decoding may be performed in the search space from index 32 to index 39. When assuming AL 8, the number of PDCCH candidates may be 2, and the size of CCEs may be 16. As illustrated in FIG. 4A, decoding may be performed in the search space from index 8 to index 23.

From a scheduling perspective, limiting the number of blind decoding attempts per AL for the terminal reduces scheduling flexibility but decreases complexity. On the other hand, allowing all possible CCE ALs increases scheduling flexibility but also increases complexity. Therefore, the maximum number of blind decoding attempts may be limited at the terminal, and a search space, which is a candidate control channel set formed by available CCEs in the scheduler during the same time, may be provided.

The terminal needs to search for possible CCE positions within the search space to find its PDCCH in the control channel region. However, in case of blind decoding, since the terminal does not have information regarding a DCI type or CCE AL for its PDCCH, the terminal needs to search at all possible CCE start positions according to the possible CCE ALs. That is, the terminal needs to perform blind decoding at all possible CCE start positions according to the possible CCE ALs. For a search space set s allocated to a CORESET p, in an active downlink (DL) BWP, a CCE index of AL L corresponding to a PDCCH candidate m_{s,n}_{_{Cl}} in the search space set within a slot

$${n}_{s , f}^{μ}$$

may be calculated as shown in Equation 1.

$$L \cdot \{ ( {Y}_{p , {n}_{s , f}^{μ}} + ⌊ \frac{{m}_{s ,} \cdot {N}_{C C E , p}}{L \cdot {M}_{s , max}^{( L )}} ⌋ + {n}_{CI} ) mod ⌊ {N}_{C C E , p} / L ⌋ \} + i \qquad [ Equation 1 ]$$

In Equation 1, for a common search space (CSS),

$${Y}_{p , {n}_{s , f}^{μ}}$$

may be set as 0. For a UE-specific search space (USS),

$${Y}_{p , {n}_{s , f}^{μ}} = ( {A}_{p} \cdot {Y}_{p , {n}_{s , f}^{μ} - 1} ) , {Y}_{p , - 1} = {n}_{RNTI} \neq 0$$

may be established. If p mod 3=0 is met, Aₚ=39827 may be established. Furthermore, if p mod 3=1 is met, Aₚ=39829 may be established. Additionally, if p mod 3=2 is met, Aₚ=39839 may be established. D may be set as 65537. N_{CCE,p} may be the number of CCEs within the CORESET p, which are sequentially indexed from 0 to N_{CCE,p}−1. If cross-carrier scheduling is applied, n_{Cl} may be a value of a carrier indicator field (CIF). For a CSS, n_{Cl}=0.

In this case, the CCE start positions for control information transmission may vary depending on the CCE AL, and control information may be transmitted by continuously allocating a number of CCEs corresponding to the AL from the start position. Here, the control information may refer to DCI.

Since information regarding the configurations and allocated resource positions of control information is not explicitly provided to the receiving end during control channel information acquisition, decoding needs to be performed for all possible configurations and resources. Different DCI formats may be transmitted through the control channel, and the receiving terminal needs to detect the DCI formats without prior knowledge. Additionally, since the terminal needs to perform PDCCH decoding without any information on the CCE AL, this process is referred to as blind decoding. Candidate allocation positions are determined according to the AL, and decoding needs to be performed at all possible positions within the limited number of blind decoding attempts.

If a single terminal needs to perform blind decoding for all combinations of CCE positions within the control channel region according to the DCI usages and CCE ALs, the number of blind decoding processes may become excessive. Therefore, to limit complexity, the maximum number of monitoring and decoding attempts per terminal may be set. This may reduce the burden on the terminal by defining candidate CCE resources for PDCCH allocation, preventing the terminal from searching over an excessively large region.

In the case of LTE, a candidate search region that a terminal needs to search for based on different ALs is restricted within a search space AL, limiting the processing to a maximum of 44 processes. In the case of NR, the number of blind decoding attempts per slot is limited based on a subcarrier spacing (SCS), supporting a maximum of 44, 36, 22, and 20 blind decoding attempts for subcarrier spacings of 15 kHz, 30 kHz, 60 kHz, and 120 kHz, respectively. The maximum number of PDCCH candidates subject to blind decoding based on subcarrier spacing configuration may be shown in Table 3.

TABLE 3

| | Maximum number of monitored PDCCH |
|---|---|
| SCS configuration | candidates per slot and per serving cell |
| μ | M_{PDCCH}^{max, slot, μ} |
| 0 | 44 |
| 1 | 36 |
| 2 | 22 |
| 3 | 20 |

Unlike LTE, the NR communication system allows the number of processes to be configured for each search space, enabling more flexible operation. Here, a search space may refer to a set of candidate control channels formed by CCEs according to an AL defined for control information decoding at the terminal.

DCI may be allocated and transmitted to available CCE resources in a CSS set region and a USS set region according to its usage. System information for all terminals, such as transmission configurations for control channels used for system information block (SIB) decoding, is allocated and transmitted in the CSS, and each AL may have a fixed number of candidates as shown in Table 4.

TABLE 4

| CCE Aggregation Level | Number of Candidates |
|---|---|
| 4 | 4 |
| 8 | 2 |
| 16 | 1 |

In case of a USS, CCE AL L may be represented as L∈{1, 2, 4, 8, 16}. The number of PDCCH candidates in a USS may be determined by subtracting the number of CSS candidates from the maximum number of PDCCH candidates monitored per slot and per serving cell.

The number of blind decoding attempts increases as more AL types are supported, as the search space needs to be expanded to support multiple terminals and verify multiple allocation positions, or as more types of DCI need to be distinguished. Considering the complexity at the receiving end, a configuration is required that maximizes scheduling flexibility within a limited number of blind decoding attempts while efficiently conveying control channel resource operation information. This approach reduces decoding complexity at the terminal and expands the available resource region. The resource operation information of the control channel explicitly or implicitly indicates the CCE AL of the resource within the control channel. This is intended to ensure scheduling flexibility of control information when allocating transmission resources according to the CCE AL and to reduce complexity caused by AL-related variables during blind decoding at the terminal.

Extremely high-frequency bands are considered suitable candidate frequency bands for high-capacity transmission due to the ease of securing available resources, with the terahertz (THz) bands being a primary candidate. Currently, backhaul and access links, which require high-capacity transmission, are leveraging the wide bandwidth of extremely high-frequency bands to develop and apply modulation and demodulation technologies suitable for high-speed transmission. In particular, for mobile wireless backhaul, various formats of control information may be required for base station scheduling and demodulation to support high-speed transmission and mobility.

Control information configuration is classified into DCI formats according to usages, and CRC bits may be appended for transmission through the control channel.

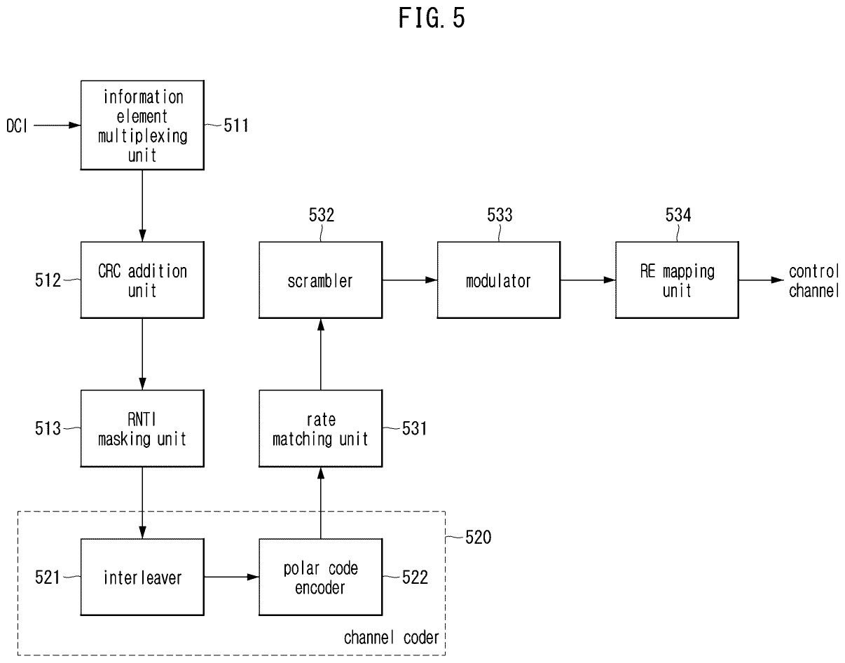

FIG. 5 is a block diagram illustrating an exemplary embodiment of a control channel transmission device for describing a procedure of processing DCI transmitted in a communication system according to an exemplary embodiment of the present disclosure.

Referring to FIG. 5, a communication system may include a control channel transmission device and may be a 5G communication system or 6G communication system. The control channel transmission device may include an information element multiplexing unit 511, a CRC addition unit 512, an RNTI masking unit 513, a channel coder 520, a rate matching unit 531, a scrambler 532, a modulator 533, and an RE mapping unit 534. Additionally, the channel coder 520 may include an interleaver 521 and a polar code encoder 522. Although FIG. 5 illustrates only the configuration for DCI processing within the control channel transmission device for convenience of description, the scope of the present disclosure is not limited thereto.

A DCI, which is control information, may be input to the CRC addition unit 512 through the information element multiplexing unit 511. The CRC addition unit 512 may calculate a CRC for bits of the DCI and append the CRC to an end of a DCI payload. Hereinafter, when describing the processing operation after the CRC addition unit 512, the DCI with the appended CRC may be referred to as ‘DCI with the appended CRC’ or simply as ‘DCI’. Even when simply referred to as ‘DCI’, it may be understood that the CRC has been appended by the CRC addition unit 512.

The DCI with the appended CRC from the CRC addition unit 512 may be input to the RNTI masking unit 513. The RNTI masking unit 513 may mask the CRC with an RNTI of a corresponding receiving node so that the receiving node can identify the DCI. Depending on a usage, the RNTI may be a C-RNTI or an RNTI for a specific purpose. The DCI masked with the RNTI of the receiving node (e.g. UE) may be input to the channel coder 520. Hereinafter, when describing the processing operation, the DCI masked with the RNTI may be referred to as ‘DCI with the masked RNTI’ or simply as ‘DCI’, for the same reason as described above.

The channel coder 520 may include the interleaver 521 and the polar code encoder 522, as described above. The interleaver 521 may interleave the DCI with the appended CRC and the masked RNTI based on a predefined scheme. The interleaved DCI from the interleaver 521 may be input to the polar code encoder 522.

The polar code encoder 522 may encode the interleaved DCI based on a polar coding scheme used in NR. The polar-coded DCI from the polar code encoder 522 may be input to the rate matching unit 531. Hereinafter, when describing the processing operation, the polar-coded DCI may be referred to as ‘polar-coded DCI’, ‘encoded DCI’, or ‘interleaved and polar-coded DCI’. This is for convenience of description, as it is widely known that NR employs polar coding for DCI encoding, and thus, no confusion is expected.

The rate matching unit 531 may perform rate matching on the encoded DCI to fit a predetermined specific length, as described above. For example, if the length of the encoded DCI is shorter than the predetermined length, repetition may be performed to match the predetermined length. Conversely, if the length of the encoded DCI is longer than the predetermined length, puncturing or shortening may be performed to adjust the length accordingly.

The rate-matched DCI output from the rate matching unit 531 may be mapped to resources of a control channel and transmitted to the receiving node. It should be noted that FIG. 5 omits the configuration for mapping the rate-matched DCI to the control channel.

As described with reference to FIG. 5, the DCI may be transmitted to the receiving node through the control channel. Since the communication system (e.g. 5G communication system or 6G communication system) is a wireless network, the control channel is transmitted over the air. The receiving node may receive the control channel and perform blind decoding in the control channel resources. That is, as described above, the receiving node needs to proceed with control channel decoding without prior knowledge of a DCI format transmitted through the control channel. In other words, the receiving node may attempt blind decoding by decoding all candidate DCI formats and the possible resource sizes without knowing (or receiving) information on the control information size or the DCI format. The total number of blind decoding attempts may be determined as a combination of the number of decoding attempts for AL(s) assigned as control channel resource information and the number of decoding attempts for DCI format(s) at the corresponding AL(s).

As described above, the maximum number of decoding attempts at the receiving node may be limited in consideration of scheduling flexibility and hardware complexity. Hereinafter, with reference to the accompanying drawings, the procedure for decoding the control channel at the receiving node will be described.

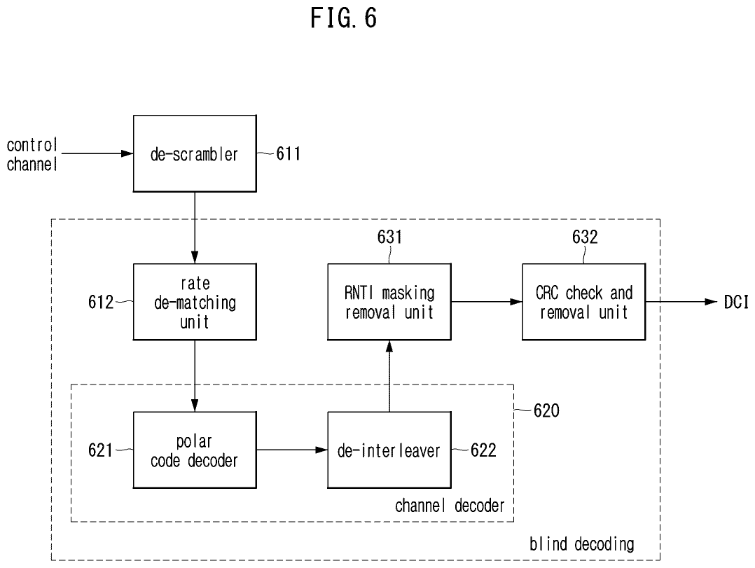

FIG. 6 is a block diagram illustrating an exemplary embodiment of a control channel reception device for describing a procedure of processing a received control channel in a communication system according to an exemplary embodiment of the present disclosure.

Referring to FIG. 6, a communication system may include a control channel reception device and may be a 5G communication system or 6G communication system. The control channel reception device may include a de-scrambler 611, a rate de-matching unit 612, a channel decoder 620, an RNTI masking removal unit 631, and a CRC check and removal unit 632. Additionally, the channel decoder 620 may include a polar code decoder 621 and a de-interleaver 622. Although FIG. 6 illustrates only the configuration corresponding to the transmission device of FIG. 5 for processing DCI within the control channel reception device for convenience of description, the scope of the present disclosure is not limited thereto.

As described with reference to FIG. 5, it can be seen that NR employs polar coding as a channel coding scheme for control channels. Therefore, the control channel reception device may receive a control channel that has undergone polar encoding and input it to the de-scrambler 611. The de-scrambler 611 may perform de-scrambling on the received control channel and provide the output to the rate de-matching unit 612.

The rate de-matching unit 612 may perform an inverse operation corresponding to the rate matching unit 531 of the control channel transmission device in FIG. 5. The rate de-matching unit 612 may remove a zero-padded portion or provide information regarding the zero-padded portion to the channel decoder 620.

The channel decoder 620 may include the polar code decoder 621 and the de-interleaver 622, as described above. Since data included in the control channel, i.e., DCI, is transmitted in a polar-coded form, the polar code decoder 621 may perform polar decoding on the received DCI and output a result. The decoded control channel data from the polar code decoder 621 may be input to the de-interleaver 622.

The de-interleaver 622 may perform de-interleaving on the decoded control channel data by reversing the interleaving process applied by the interleaver 521 described in FIG. 5. Through the operations of the polar code decoder 621 and the de-interleaver 622, channel decoding may be performed.

The decoded data may be input to the RNTI masking removal unit 631. The RNTI masking removal unit 631 may perform an inverse process corresponding to the RNTI masking unit 513 described in FIG. 5 to remove the RNTI masking. In this case, the RNTI masking removal unit 631 of the receiving node may remove the masking using a C-RNTI received from a serving cell or an RNTI for a specific purpose. The RNTI masking removal unit 631 may output the data after removing the masking.

The data with the masking removed may be input to the CRC check and removal unit 632. The CRC check and removal unit 632 may verify a CRC and, if no error is detected in the CRC check result, obtain the DCI transmitted through the control channel. Therefore, the CRC check and removal unit 632 may output the DCI with the CRC removed if no error is detected in the CRC verification. On the other hand, if an error is detected in the CRC verification, the received data may be discarded. Since error correction cannot be performed using the CRC, any data with a CRC error is discarded. This occurs either when the receiving node attempts to remove the RNTI masking using an incorrect RNTI—indicating that the data was not intended for the receiving node—or when the data was intended for the receiving node but could not be properly recovered.

The transmitting node (e.g. base station) may allocate a control channel resource to each receiving node (e.g. UE) for restoring each piece of control information within a control channel. The transmitting node may allocate a control channel resource according to a channel state or purpose, assigning from 1 CCE up to 8 CCEs or 16 CCEs. When this resource allocation is denoted as AL 1 to AL 16, in a conventional NR configuration, if cell-specific control information in a CSS is recovered without additional information from the transmitting node, AL values of {4, 8, 16} may be used. On the other hand, when recovering UE-specific control information, all possible AL values may be considered for decoding. When blind decoding is performed in this process, the input signal for polar decoding may vary depending on the resource allocation size, requiring individual processing for each decoding attempt. In consideration of hardware complexity, a 5G communication system or 6G communication system may limit the number of decoding attempts per receiving node to a maximum of 44 within CSS/USS. If the receiving node is aware of the AL information for each available CCE within the control channel, the receiving node may avoid redundant decoding attempts that apply different CCE ALs to the same CCE resource. Therefore, the receiving node may be able to apply the same number of decoding attempts to a larger set of resources or perform decoding with a reduced number of attempts within the same resource set.

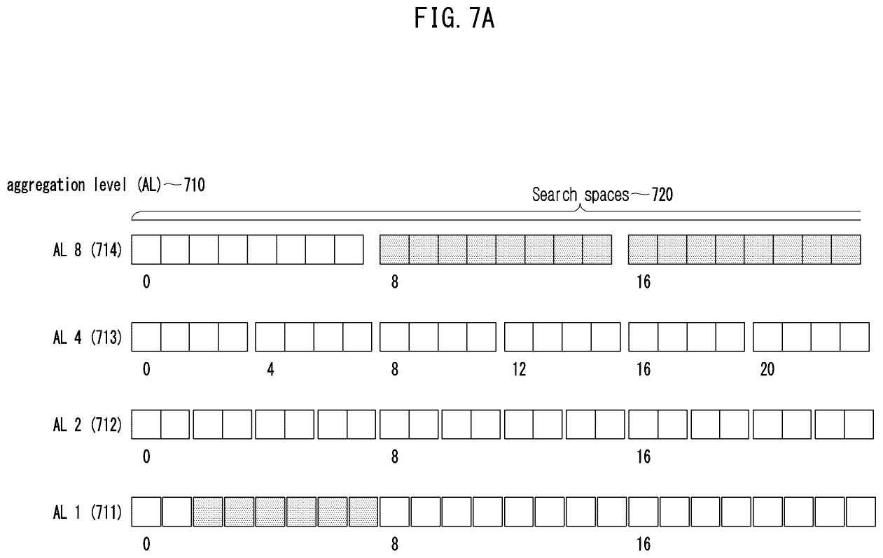

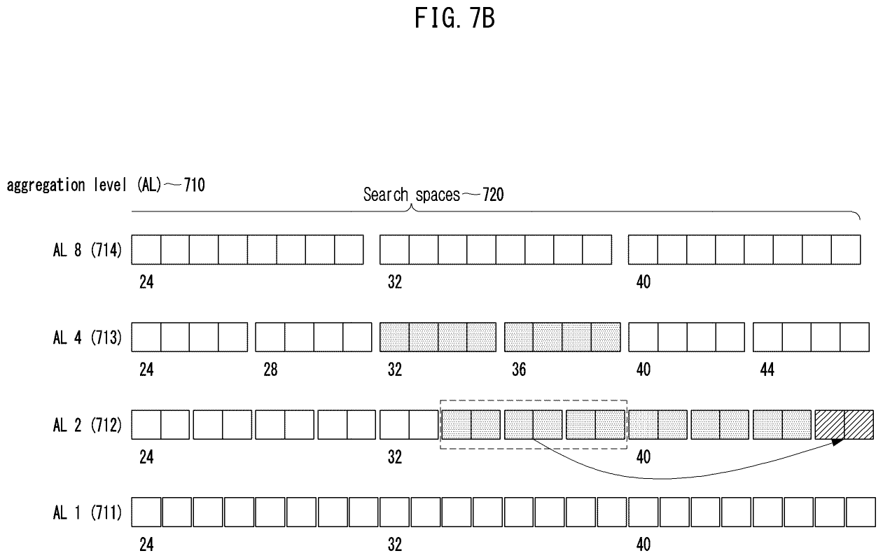

FIG. 7A is a conceptual diagram illustrating a portion of an exemplary embodiment for describing overlap of CCE ALs in a search space according to an exemplary embodiment of the present disclosure, and FIG. 7B is a conceptual diagram illustrating the remaining portion of the exemplary embodiment for describing the overlap of CCE ALs in a search space according to an exemplary embodiment of the present disclosure.

Referring to FIG. 7A and FIG. 7B, AL 710 may be classified into four levels: AL 1 711, AL 2 712, AL 4 713, and AL 8 714. A search space 720 may include 48 CCEs, ranging from the 0th CCE to the 47th CCE. The 34th to 39th CCEs may form a section in which AL 4 and AL 2 overlap in the search space 720. The 34th to 39th CCEs may form a candidate section that is redundantly decoded with different ALs. If AL information exists for the section of the 34th to 39^{th} CCEs, redundant decoding attempts may be reduced. If the AL information for the section of the 34th to 39th CCEs indicates AL 4, a resource allocation region for AL 2 may be configured as starting from the 40th CCE, where the overlapping section ends. When the per-CCE AL information is provided from the transmitting node to the receiving node, the receiving node may expand the search area for recovery by setting the resource allocation section for AL 2 in units of two CCEs. Here, the receiving node may include at least one of a UE, or a DU or RU according to the O-RAN communication specifications. The transmitting node may include at least one of a base station, a CU, a DU, and/or an RU of the O-RAN communication specifications.

Generally, a DCI included in a PDCCH with AL L may be mapped to multiple REGs within a CORESET in units of L sequentially indexed CCEs. The CCEs may be sequentially indexed as 0, 1, 2, . . . , and the like. If the AL is 4, PDCCH allocation may start from the 0th, 4th, 8th, . . . , 4n-th CCE and span 4 consecutive CCEs. Through this process, the PDCCHs to be transmitted may be allocated to the control channel region. The receiving node (e.g. UE) may decode the PDCCH using four UE-specific search space ALs: AL 1, AL 2, AL 4, and AL 8.

Referring to FIG. 7A and FIG. 7B, the receiving node (e.g. UE) may perform decoding with AL 1. In this case, the number of PDCCH candidates may be 6, and the size of CCEs may be 6. As illustrated in FIG. 7A, the receiving node may perform decoding in the search space from index 2 to index 7. Additionally, the receiving node may perform decoding with AL 2. In this case, the number of PDCCH candidates may be 6, and the size of CCEs may be 12. As illustrated in FIG. 7B, the receiving node may perform decoding in the search space from index 34 to index 45. Furthermore, the receiving node may perform decoding with AL 4. In this case, the number of PDCCH candidates may be 2, and the size of CCEs may be 4. As illustrated in FIG. 7B, the receiving node may perform decoding in the search space from index 32 to index 39. Additionally, the receiving node may perform decoding with AL 8. In this case, the number of PDCCH candidates may be 2, and the size of CCEs may be 16. As illustrated in FIG. 7A, the receiving node may perform decoding in the search space from index 8 to index 23.

Referring to FIG. 7A and FIG. 7B, the candidate allocated resource positions of control information for the receiving node (e.g. UE) may be determined based on Equation 1 using RNTI, AL, and carrier information. The transmitting node (e.g. base station) may allocate control information for multiple receiving nodes based on the respective receiving nodes' ALs. In this case, candidate positions according to AL-based allocations for a single receiving node may overlap. The 34th to 39th CCEs, which forms an overlapping section of AL 4 and AL 2, may serve as a candidate section for redundant decoding. If per-CCE AL information exists for the overlapping section of AL 4 and AL 2, the receiving node may reduce redundant decoding attempts. The receiving node may utilize the remaining decoding attempts to expand the search region. Additionally, if per-CCE AL information is available, it may enhance scheduling flexibility. As illustrated in FIG. 7B, the transmitting node may configure the section starting from the 40th CCE, where the overlapping section ends, as the resource allocation region for AL 2. The receiving node may expand the search region in units of two CCEs from the 40th CCE. In other words, the receiving node may perform decoding in the search space from index 40 to index 47.

If per-CCE AL information is provided from the transmitting node to the receiving node, the receiving node may attempt decoding only at CCEs where the per-CCE AL information matches within the AL-based search region. Therefore, the receiving node may reduce the resources required for decoding (e.g. decoding processors or decoding processes).

The receiving node (e.g. UE) may obtain and use per-CCE AL information from a specific resource to improve efficiency in decoding attempts. Additionally, when the per-CCE AL information is provided from the transmitting node (e.g. base station) to the receiving node, position variables determined according to the AL may be excluded. Furthermore, the transmitting node may be able to perform control channel scheduling for multiple receiving nodes more flexibly within the control channel region.

A method for obtaining per-CCE AL information of a control channel may be categorized into a method of allocating a specific channel for information delivery, a method of configuring a DCI format for per-CCE AL information and transmitting it in a common region, or a method of directly obtaining the information using RS(s) within a CCE.

When a channel condition does not change significantly over time and, as a result, updates to the per-CCE AL information in the control channel are infrequent, the information may be transmitted by including it in periodically delivered information such as a physical broadcast channel (PBCH). However, in an environment where a transmission channel undergoes frequent time variation, CCE resource allocation information for a control channel of the receiving node (e.g. UE) needs to be dynamically transmitted within a slot through a control channel or a specific resource. Here, the CCE resource allocation information may include the per-CCE AL information.

As a first configuration method for per-CCE AL information transmission, a method of allocating and transmitting a specific channel may be proposed. The per-CCE AL information may include information for aggregation of each CCE (e.g. AL information).

In the resources for the control channel, a CCE may be used as a basic unit for DCI transmission. A single DCI may be transmitted by allocating one, two, four, or eight CCEs as needed. Additionally, a single DCI may be transmitted by allocating 16 CCEs as needed. The number of aggregated CCEs used for a single DCI transmission may be expressed as a CCE AL. When a DCI is transmitted as UE-specific information, the per-CCE AL may indicate CCE allocation information as a representative value, as shown in Table 5.

TABLE 5

| | Aggregation |
|---|---|
| CCE information field | level |
| 00 | 1 |
| 01 | 2 |
| 10 | 4 |
| 11 | 8 |

In Table 5, a CCE information field may be represented using two bits. When the CCE information field is set to ‘00’, the CCE AL may be 1, indicating that one CCE is allocated. In other words, a single DCI may be transmitted by allocating one CCE. When the CCE information field is set to ‘01’, the CCE AL may be 2, indicating that two CCEs are allocated. In other words, two CCEs may be aggregated, and a single DCI may be transmitted by allocating two CCEs. When the CCE information field is set to ‘10’, the CCE AL may be 4, indicating that four CCEs are allocated. In other words, four CCEs may be aggregated, and a single DCI may be transmitted by allocating four CCEs. When the CCE information field is set to ‘11’, the CCE AL may be 8, indicating that eight CCEs are allocated. In other words, eight CCEs may be aggregated, and a single DCI may be transmitted by allocating eight CCEs.

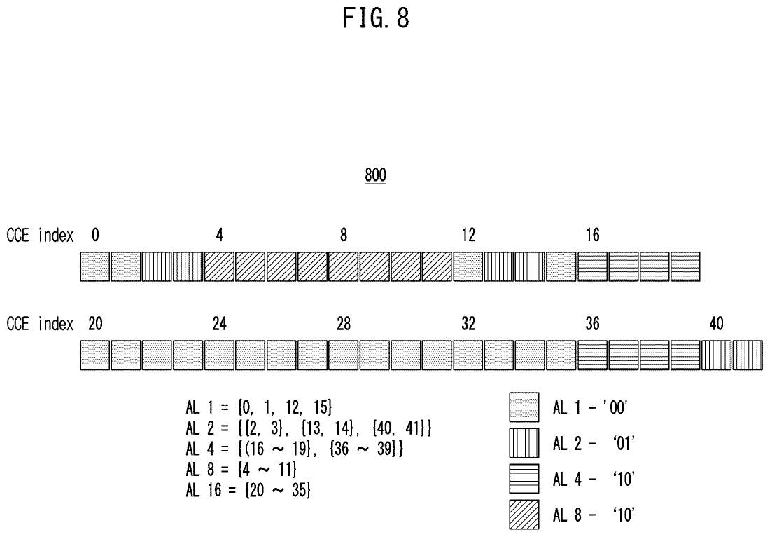

FIG. 8 is a conceptual diagram illustrating an exemplary embodiment of a first configuration method for per-CCE AL information transmission according to an exemplary embodiment of the present disclosure.

Referring to FIG. 8, in the first configuration method for per-CCE AL information transmission according to an exemplary embodiment of the present disclosure, an exemplary embodiment 800 of per-CCE AL information (hereinafter, an exemplary embodiment of first per-CCE AL information) may include AL information of each of N CCEs. The AL information of each of the N CCEs may be represented using two bits. A bit sequence of ‘00’ may indicate AL 1, a bit sequence of ‘01’ may indicate AL 2, a bit sequence of ‘10’ may indicate AL 4, and a bit sequence of ‘11’ may indicate AL 8. A consecutive 16 sequences of ‘00’ may indicate AL 16. This may also be used when transmitting cell characteristic information using the CCE AL. Although FIG. 8 illustrates 43 CCEs, this is merely for convenience of description and is not limited thereto. Here, N may be a natural number equal to or greater than 1.

As shown in FIG. 8, in the exemplary embodiment 800 of the first per-CCE AL information, AL 1 may be represented as ‘01’, and AL 1 may be applied to CCEs indexed as 0, 1, 12, and 15. AL 2 may be represented as bit ‘01’, and AL 2 may be applied to CCEs indexed as 2 and 3, CCEs indexed as 13 and 14, and CCEs indexed as 40 and 41. AL 4 may be represented as bit ‘10’, and AL 4 may be applied to CCEs indexed from 16 to 19 and CCEs indexed from 36 to 39. AL 8 may be represented as bit ‘11’, and AL 8 may be applied to CCEs indexed from 4 to 11. In contrast, consecutive 16 sequences of ‘00’ may be identified as AL 16, and AL 16 may be applied to CCEs indexed from 20 to 35.

The per-CCE AL information may be transmitted by allocating a portion of the control channel region resources. Additionally, a separate channel may be configured to transmit the per-CCE AL information. When a separate channel is configured for per-CCE AL information transmission, the separate channel may be referred to as a physical control aggregation level information indicator channel (PCAICH). The PCAICH may be transmitted at a specific position from the base station in the communication system (e.g. 5G communication system or 6G communication system), similarly to a PBCH, and multiple terminals may detect the PCAICH. When the PCAICH is transmitted, the PCAICH may undergo channel coding and be transmitted as follows to enhance transmission capability. Here, the multiple terminals may refer to terminals located within a coverage of the base station. The base station may be referred to as a transmitting node, and the terminal may be referred to as a receiving node.

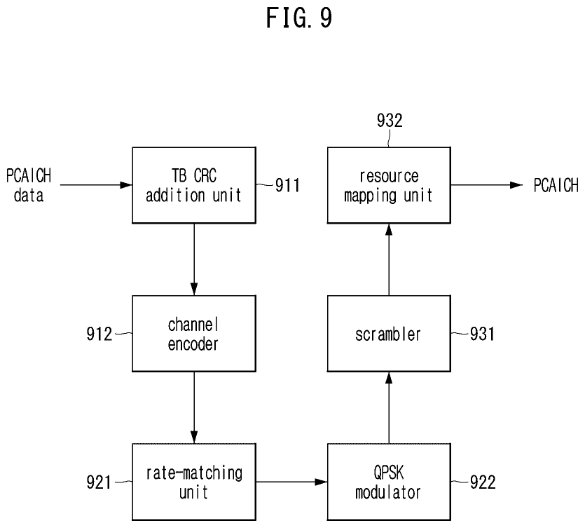

FIG. 9 is a block diagram illustrating an exemplary embodiment of a method for transmitting per-CCE AL information in the first configuration method for per-CCE AL information transmission according to an exemplary embodiment of the present disclosure.

Referring to FIG. 9, in the first configuration method for per-CCE AL information transmission according to an exemplary embodiment of the present disclosure, an exemplary embodiment of a method for transmitting per-CCE AL information (hereinafter, an exemplary embodiment of the AL transmission method) may be performed by a transport block (TB) CRC addition unit 911, a channel encoder 912, a rate matching unit 921, a QPSK modulator 922, a scrambler 931, and a resource mapping unit 932. The per-CCE AL information may be represented as PCAICH data, and the PCAICH may refer to a channel that is allocated within a portion of the control channel region resources. The block diagram illustrated in FIG. 9 is provided for convenience of description and is not limited thereto.

As shown in FIG. 9, in an exemplary embodiment of the AL transmission method, a CRC may be added to 2N-bit per-CCE AL information to be transmitted. Subsequently, the PCAICH may be transmitted by mapping a transmission resource to a specific position resource through channel coding, rate matching, scrambling, modulation, and resource mapping. The resource for transmitting the PCAICH may be provided as a higher layer parameter. Alternatively, the resource for transmitting the PCAICH may be allocated to allow operations even in cases where the predetermined position resource has low channel quality by applying a low code rate. As described above, the control channel may include N CCEs, and the AL information of each of the N CCEs may be represented using two bits.

In the communication system (e.g. 5G communication system or 6G communication system), when the base station transmits a PBCH, the base station may generate a 32-bit payload by adding 8 bits of additional timing-related information to a 24-bit data portion. After the 32-bit payload is generated, the base station may scramble the payload using a scrambling sequence. Then, the base station may add CRC bits using g_{CRC24C}(D) of 24 bits. The base station may map the information bits to resources by applying channel coding, rate matching, and QPSK modulation to produce an output of length 864. The first AL transmission method may be performed by further using a scrambler for scrambling the PCAICH data using a scrambling sequence in the same or similar manner as PBCH before adding the CRC to the PCAICH data. The PCAICH data may be referred to as a PCAICH payload.

The transmitting node (e.g. base station) may configure the PCAICH payload as 2N bits (e.g. α₀α₁α₂ . . . α_{2N-1}) in ascending order of CCE indexes. As shown in FIG. 9, the transmitting node may transmit the PCAICH to receiving nodes by applying CRC addition, channel coding, rate matching, scrambling, QPSK modulation, and resource mapping to the PCAICH payload. Here, N may be a natural number equal to or greater than 1. Each receiving node (e.g. UE) may receive the PCAICH from the transmitting node and acquire the PCAICH payload. Each receiving node may perform decoding based on the per-CCE AL information. For example, when the AL information indicates AL 1 for a CCE index, each receiving node may perform decoding using a single CCE resource for the resource at the position corresponding to the CCE index. When the AL information indicates AL 2, AL 4, or AL 8 for a CCE index, each receiving node may perform decoding by aggregating CCE resources in an amount corresponding to the AL at the positions where the same AL is applied. When the number of CCEs for the CCE-based control channel region is N, AL information for each resource may be allocated using two bits through QPSK modulation. The total AL information to be transmitted within the control channel may be 2N bits. When resources are allocated as expressed in Equation 1, CCEs may be provided to receiving nodes as transmission resources by aggregating consecutive CCE resources according to AL information. Here, an AL size may refer to the CCE AL, as shown in Table 5. In other words, when the per-CCE AL information is ‘00’, it may be expressed as AL 1, and the AL size may be 1. When the per-CCE AL information is ‘01’, it may be expressed as AL 2, and the AL size may be 2. When the per-CCE AL information is ‘10’, it may be expressed as AL 4, and the AL size may be 4. When the per-CCE AL information is ‘11’, it may be expressed as AL 8, and the AL size may be 8.

When the per-CCE AL information is sequentially the same from the lowest CCE index at the receiving node (e.g. UE), the receiving node may determine the size of CCEs for control information and perform decoding based on the per-CCE AL information.

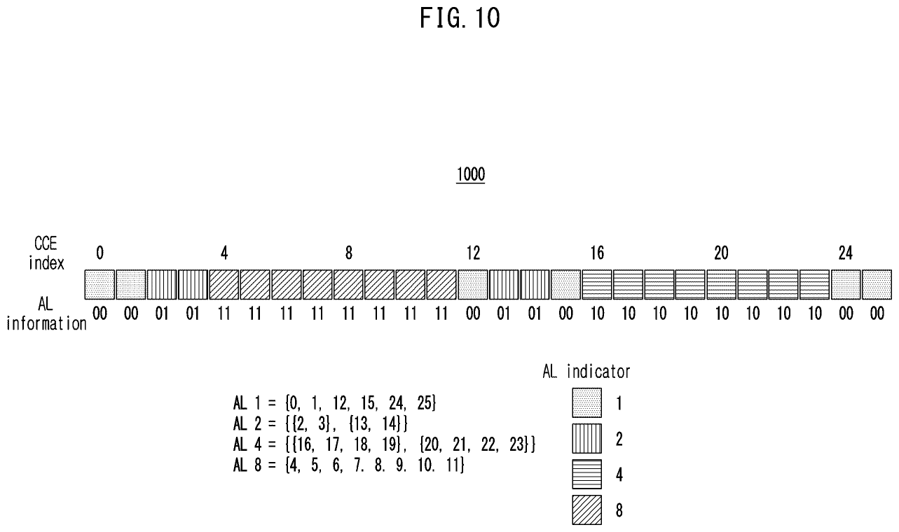

FIG. 10 is a conceptual diagram illustrating an exemplary embodiment of a method for decoding a control channel using per-CCE AL information according to an exemplary embodiment of the present disclosure.

Referring to FIG. 10, in an exemplary embodiment 1000 of a method for decoding a control channel using per-CCE AL information according to an exemplary embodiment of the present disclosure (hereinafter, an exemplary embodiment of the decoding method), a receiving node (e.g. UE) may receive per-CCE AL information from a transmitting node (e.g. base station). The per-CCE AL information may include AL information for each of a plurality of CCEs, and each AL information may be represented using two bits. The two bits in the AL information may correspond to AL information for a single CCE, and the two bits in the AL information may serve as an AL indicator indicating aggregation (or combination) for a single CCE. When the AL information is sequentially identical from the lowest CCE index, the receiving node may determine the size of CCEs for control information based on the AL information and perform decoding. When the two bits in the AL information are ‘00’, the AL indicator may be 1, and the receiving node may determine the size of CCEs for control information as 1 and perform decoding using a single CCE. When the two bits in the AL information are ‘01’, the AL indicator may be 2. The receiving node may determine the size of CCEs for control information as 2 and perform decoding by using two consecutive CCEs having the same ‘01’. When the two bits in the AL information are ‘10’, the AL indicator may be 4. The receiving node may determine the size of CCEs for control information as 4 and perform decoding by using four consecutive CCEs having the same ‘10’. When the two bits in the AL information are ‘11’, the AL indicator may be 8. The receiving node may determine the size of CCEs for control information as 8 and perform decoding by using eight consecutive CCEs having the same ‘11’. Here, the two-bit AL information may be represented as an AL indicator. When the two bits in the AL information are ‘00’ and a consecutive sequence of 16 ‘00’ bits is identified, the receiving node may determine the size of CCEs for control information as 16 and perform decoding by using 16 consecutive CCEs having the same ‘00’.

In the exemplary embodiment 1000 of the decoding method, the receiving node may sequentially check the AL indicators from CCE index 0 to 25 in the per-CCE AL information to obtain AL 1, AL 2, AL 4, and AL 8 for aggregating CCEs. AL 1 may be applied to CCEs indexed as 0, 1, 12, and 15, and the receiving node may perform decoding using a single CCE corresponding to each of CCE indexes 0, 1, 12, and 15 to which AL 1 is applied. AL 2 may be applied to CCEs indexed as 2 and 3, as well as CCEs indexed as 13 and 14. The receiving node may perform decoding by using two CCE resources corresponding to CCE indexes 2 and 3 to which AL 2 is applied. Additionally, the receiving node may perform decoding by using two CCEs indexed as 13 and 14 to which AL 2 is applied. AL 4 may be applied to CCEs indexed from 16 to 19 and CCEs indexed from 20 to 23, and the receiving node may perform decoding by using four CCEs indexed from 16 to 19 to which AL 4 is applied. Additionally, the receiving node may perform decoding by using four CCEs indexed from 20 to 23 to which AL 4 is applied. AL 8 may be applied to CCEs indexed from 4 to 11, and the receiving node may perform decoding by using eight CCEs indexed from 4 to 11 to which AL 8 is applied.

When the transmitting node transmits per-CCE AL information to the receiving node(s), the receiving node(s) may use one or more CCEs to decode a single DCI. The one or more CCEs may not necessarily be continuous, as follows.

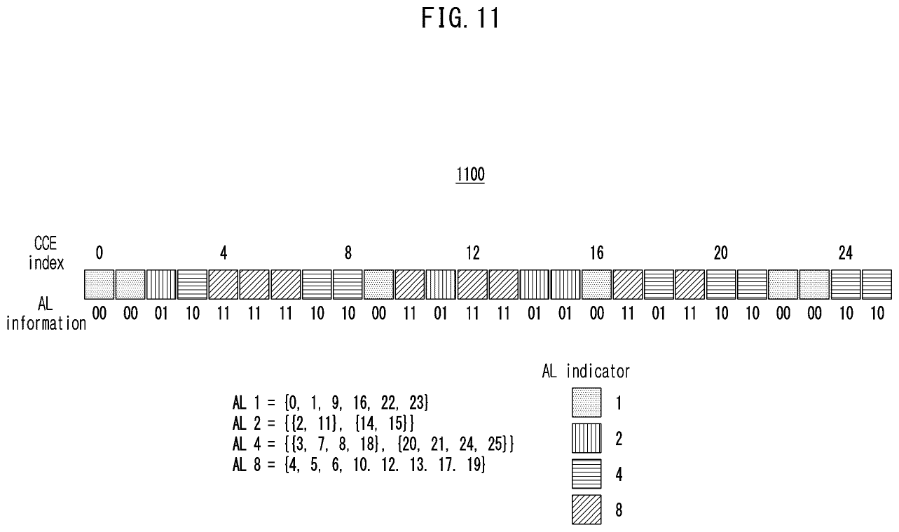

FIG. 11 is a conceptual diagram illustrating another exemplary embodiment of a method for decoding a control channel using per-CCE AL information according to an exemplary embodiment of the present disclosure.

Referring to FIG. 11, in another exemplary embodiment 1100 of a method for decoding a control channel using per-CCE AL information according to an exemplary embodiment of the present disclosure (hereinafter, another exemplary embodiment of the decoding method), a receiving node (e.g. UE) may receive per-CCE AL information from a transmitting node (e.g. base station). The per-CCE AL information may include AL information for each of a plurality of CCEs, and each AL information may be represented using two bits. The two bits in the AL information may correspond to AL information for a single CCE, and the two bits in the AL information may serve as an AL indicator indicating aggregation (or combination) for a single CCE. The receiving node may determine the size of CCEs (i.e. the number of CCEs) for control information as 1 and perform decoding using a single CCE. When the two bits in the AL information are ‘01’, the AL indicator may be 2. The receiving node may determine the size of CCEs for control information as 2 and perform decoding by using the next CCE having the same AL information ‘01’ together. When the two bits in the AL information are ‘10’, the AL indicator may be 4. The receiving node may determine the size of CCEs for control information as 4 and perform decoding by sequentially using four CCEs having the same AL information ‘10’ together. When the two bits in the AL information are ‘11’, the AL indicator may be 8. The receiving node may determine the size of CCEs for control information as 8 and perform decoding by sequentially using eight CCEs having the same AL information ‘11’ together. AL 2, AL 4, and AL 8 may each include non-contiguous CCE indexes. Here, the two-bit AL information may be represented as an AL indicator.

In another exemplary embodiment 1100 of the decoding method, the receiving node may sequentially check the AL indicators from CCE indexes 0 to 25 in the per-CCE AL information to obtain AL 1, AL 2, AL 4, and AL 8 for aggregating CCEs. AL 1 may be applied to CCEs indexed as 0, 1, 9, 16, 22, and 23, and the receiving node may perform decoding using a single CCE resource corresponding to each of CCEs indexed as 0, 1, 9, 16, 22, and 23 to which AL 1 is applied. AL 2 may be applied to CCEs indexed as 2 and 11, as well as CCEs indexed as 14 and 15. The receiving node may perform decoding by using two non-contiguous CCEs corresponding to CCE indexes 2 and 11 to which AL 2 is applied. Additionally, the receiving node may perform decoding by using two contiguous CCEs corresponding to CCE indexes 14 and 15 to which AL 2 is applied. AL 4 may be applied to CCEs indexed as 3, 7, 8, and 18, as well as CCEs indexed as 20, 21, 24, and 25, and the receiving node may perform decoding by using four non-contiguous CCEs corresponding to CCE indexes 3, 7, 8, and 18 included to which AL 4 is applied. Additionally, the receiving node may perform decoding by using four non-contiguous CCEs corresponding to CCE indexes 20, 21, 24, and 25 to which AL 4 is applied. AL 8 may be applied to CCEs indexed as 4, 5, 6, 10, 12, 13, 17, and 19, and the receiving node may perform decoding by using eight non-contiguous CCEs corresponding to CCE indexes 4, 5, 6, 10, 12, 13, 17, and 19 to which AL 8 is applied.

The base station may transmit AL information for all CCEs within the control channel region to terminals. Each terminal may receive the AL information for all CCEs from the base station and reconstruct the AL information for the CCEs. Each terminal may sequentially classify the AL information for CCEs having the same AL information from the lowest CCE index. Each terminal may aggregate CCEs according to the AL information and perform decoding. In this case, the base station may perform scheduling regardless of RNTI information or AL size of each receiving terminal. Each CCE may be used as a resource corresponding to a single AL, and all CCEs may be used for any AL regardless of positions. Here, the base station may refer to the transmitting node, and the terminal may refer to the receiving node.

The transmitting node may transmit per-CCE AL information to receiving nodes, and each receiving node may receive the per-CCE AL information from the transmitting node. Each receiving node may perform decoding of control information based on the per-CCE AL information. Additionally, each receiving node may identify its control information through a CRC verification process using the RNTI. When each receiving node identifies the control information as its own control information, the receiving node may acquire the control information. During the CRC verification process using the RNTI, each receiving node may identify a CRC verification position using the RNTI at the last position of the AL of the CCEs without overlapping with other receiving nodes. The CRC verification process using the RNTI may be referred to as RNTI check.

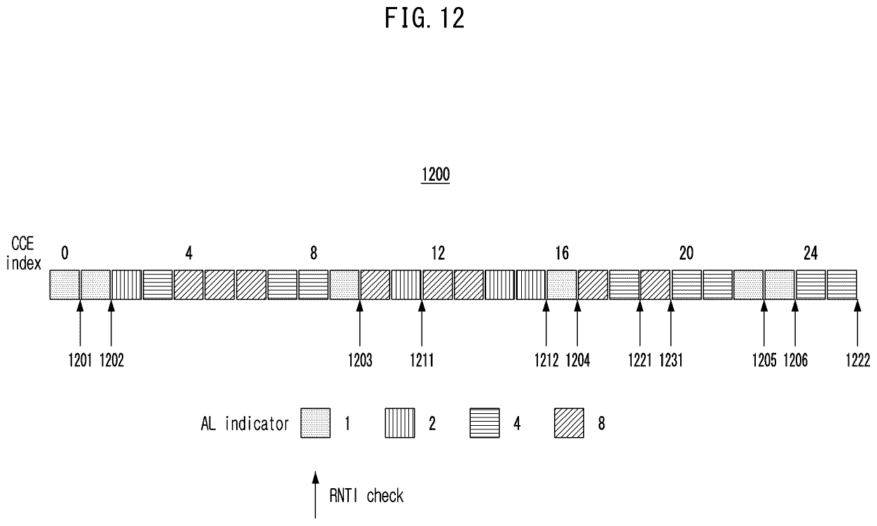

FIG. 12 is a conceptual diagram illustrating an exemplary embodiment of a method for identifying whether control information is received using per-CCE AL information according to an exemplary embodiment of the present disclosure.

Referring to FIG. 12, in an exemplary embodiment 1200 of a method for identifying whether control information is received using per-CCE AL information according to an exemplary embodiment of the present disclosure (hereinafter, an exemplary embodiment of the reception determination method), a receiving node may perform decoding of control information based on per-CCE AL information. To determine whether control information is received, the receiving node may perform multiple RNTI checks (i.e. RNTI check #1 1201, RNTI check #2 1202, RNTI check #3 1203, RNTI check #4 1204, RNTI check #5 1205, RNTI check #6 1206, RNTI check #7 1211, RNTI check #8 1212, RNTI check #9 1221, RNTI check #10 1222, RNTI check #11 1231) based on the CCE AL information. Each of the multiple RNTI checks (i.e. RNTI check #1 1201, RNTI check #2 1202, RNTI check #3 1203, RNTI check #4 1204, RNTI check #5 1205, RNTI check #6 1206, RNTI check #7 1211, RNTI check #8 1212, RNTI check #9 1221, RNTI check #10 1222, RNTI check #11 1231) may not overlap with each other. The multiple RNTI checks (i.e. RNTI check #1 1201, RNTI check #2 1202, RNTI check #3 1203, RNTI check #4 1204, RNTI check #5 1205, RNTI check #6 1206, RNTI check #7 1211, RNTI check #8 1212, RNTI check #9 1221, RNTI check #10 1222, RNTI check #11 1231) may be classified into a first RNTI check set, a second RNTI check set, a third RNTI check set, and a fourth RNTI check set according to AL indicators. The first RNTI check set may include the RNTI check #1 1201, RNTI check #2 1202, RNTI check #3 1203, RNTI check #4 1204, RNTI check #5 1205, and RNTI check #6 1206, which are performed at CCE indexes corresponding to the AL indicator 1. The second RNTI check set may include the RNTI check #7 1211 and RNTI check #8 1212, which are performed at CCE indexes corresponding to the AL indicator 2. The third RNTI check set may include the RNTI check #9 1221 and RNTI check #10 1222, which are performed at CCE indexes corresponding to the AL indicator 4. The fourth RNTI check set may include the RNTI check #11 1231, which is performed at a CCE index corresponding to the AL indicator 8.

In the exemplary embodiment 1200 of the reception determination method, the receiving node may perform an RNTI check to determine whether received control information corresponds to its own control information. The position where the receiving node performs the RNTI check may be the last position of the AL of CCEs. Here, the position may refer to an execution timing, and the position where the receiving node performs the RNTI check may be a starting point at which the receiving node performs the RNTI check. The starting point at which the receiving node performs the RNTI check may be a point in time after aggregation of CCEs is completed based on the per-CCE AL information.

In the exemplary embodiment 1200 of the reception determination method, the first RNTI check set may include the RNTI check #1 1201, RNTI check #2 1202, RNTI check #3 1203, RNTI check #4 1204, RNTI check #5 1205, and RNTI check #6 1206. The receiving node may perform each of the RNTI check #1 1201, RNTI check #2 1202, RNTI check #3 1203, RNTI check #4 1204, RNTI check #5 1205, and RNTI check #6 1206, which correspond to the AL indicator 1. The RNTI check #1 1201 may be performed at the last position of the CCE index 0. The RNTI check #2 1202 may be performed at the last position of the CCE index 1. The RNTI check #3 1203 may be performed at the last position of the CCE index 9. The RNTI check #4 1204 may be performed at the last position of the CCE index 16. The RNTI check #5 1205 may be performed at the last position of the CCE index 22. The RNTI check #6 1206 may be performed at the last position of the CCE index 23.

In the exemplary embodiment 1200 of the reception determination method, the second RNTI check set may include the RNTI check #7 1211 and RNTI check #8 1212. The receiving node may perform each of the RNTI check #7 1211 and RNTI check #8 1212, which correspond to the AL indicator 2. The RNTI check #7 1211 may be performed at the last position of the CCE index 11, and the RNTI check #8 1212 may be performed at the last position of the CCE index 15.

In the exemplary embodiment 1200 of the reception determination method, the third RNTI check set may include the RNTI check #9 1221 and RNTI check #10 1222. The receiving node may perform each of the RNTI check #9 1221 and RNTI check #10 1222, which correspond to the AL indicator 4. The RNTI check #9 1221 may be performed at the last position of the CCE index 18, and the RNTI check #10 1222 may be performed at the last position of the CCE index 25.

In the exemplary embodiment 1200 of the reception determination method, the fourth RNTI check set may include the RNTI check #11 1231. The receiving node may perform the RNTI check #11 1231, which corresponds to the AL indicator 8. The RNTI check #11 1231 may be performed at the last position of the CCE index 19.

As described above, the first configuration method for per-CCE AL information transmission may reduce the number of decoding attempts for control channel resources of the same size compared to conventional methods. When all receiving nodes (e.g. UEs) can be allocated to all resources, control channel resources may be fully utilized without restriction for RNTI and AL information of each receiving node.

As a second configuration method for per-CCE AL information transmission, a method of allocating a new DCI format to deliver data listing AL information of the respective CCEs through a control channel may be proposed. The ALs of CCEs for the new DCI format may be transmitted within a predefined size in a common search space.

When configuring the information in form of a DCI format, the DCI format in the communication system (e.g. 5G communication system or 6G communication system) may be defined and transmitted for purposes other than scheduling. When the DCI format for per-CCE AL information transmission is configured, the AL information for each CCE may be attached in 2-bit units for the number of supported CCEs and transmitted through the control channel in the order of CCE resource indexing as follows:
CCE 1, CCE 2, . . . , CCE N

Here, N may be a natural number equal to or greater than 1.

The DCI format for per-CCE AL information transmission may be scrambled with a Control Channel CCE Information (C3I)-RNTI). Here, the C3I-RNTI may be configured as a 16-bit value like other RNTIs. Additionally, the C3I-RNTI may be assigned a value between 0x0001 and 0xFFEF to avoid overlapping with RNTIs used for other purposes and may be used for information identification.

DCI may be allocated to available CCE resources in either a CSS set region or a USS set region, depending on its purpose. The DCI format for delivering per-CCE AL information to terminals for DCI decoding may undergo a recovery process with a predefined AL in a predefined search space. The search space may be classified according to the DCI format, as shown in Table 6.

TABLE 6

| Type | Scrambling RNTI | DCI format | usage |
|---|---|---|---|
| CSS | SI-RNTI | 1_0 | SIB1 and other SIBs |
| | RA-RNTI, TC- | 0_0, 1_0 | MSG2, MSG4 in |
| | RNTI, C-RNTI | | RACH procedure |
| | P-RNTI | 1_0 | Paging message |
| | INT-RNTI, SFI- | 0_0, 1_0, 2_0, | Misc. |
| | RNTI, TPC-PUSCH- | 2_1, 2_2, 2_3, | |
| | RNTI, | 2_4, 2_5, 2_6 | |
| | TPC-PUCCH-RNTI | | |
| | C-RNTI, MCS-C- | | |
| | RNTI, CS-RNTI | | |
| | ci-RNTI, AI-RNTI, | | |
| | PS-RNTI | | |
| | C3I-RNTI | 2_x | CCE aggregation level |
| USS | C-RNTI, MCS-C- | 0_0, 0_1, 1_0, | UE scheduling |
| | RNTI, SP-CSI- | 1_1 | |
| | RNTI, CS-RNTI | | |

The control information transmitted from the base station to the terminal may have a different resource position according to its purpose. When the control information needs to be received by all terminals within a service area supported by the control information, the control information may be formatted as a DCI format corresponding to its purpose in the CSS region, and after CRC addition, it may be masked with the corresponding RNTI before transmission. Examples of such information may include system information transmission, paging for initiating communication, response to PRACH transmission, uplink power control, and slot format indication, and the like. For uplink/downlink scheduling purpose for a specific terminal, control information may be transmitted through a USS region. If the new DCI format for notifying the per-CCE AL information of the control channel is referred to as 2_x, the new DCI format may be transmitted using a CSS region to ensure that the information is delivered to all terminals. Here, the base station may refer to the transmitting node, and the terminal may refer to the receiving node.

The terminal may attempt blind decoding of other control information based on the restored per-CCE AL information verified through the C3I-RNTI in the CSS region. When the terminal acquires AL information for each CCE, the terminal may aggregate resources according to the CCE AL and perform recovery for single control information, similarly to the first configuration method.

As a third configuration method for per-CCE AL information transmission, a method of delivering per-CCE AL information using reference signal(s) within each CCE may be proposed. Here, the reference signal may be referred to as a CCE information-reference signal (CI-RS).

The third configuration method for per-CCE AL information transmission may be a method of obtaining AL information values by utilizing phase information of specific subcarrier(s) within each CCE, and aggregating CCE resources accordingly. Unlike the first and second configuration methods, the third configuration method may allow direct identification of AL information and determination of a resource size required for control information decoding without additional information transmission for each CCE. The phase information representing AL information may be spaced at predetermined angles (e.g. 45 degrees) and may be intuitively used without a restoration process.

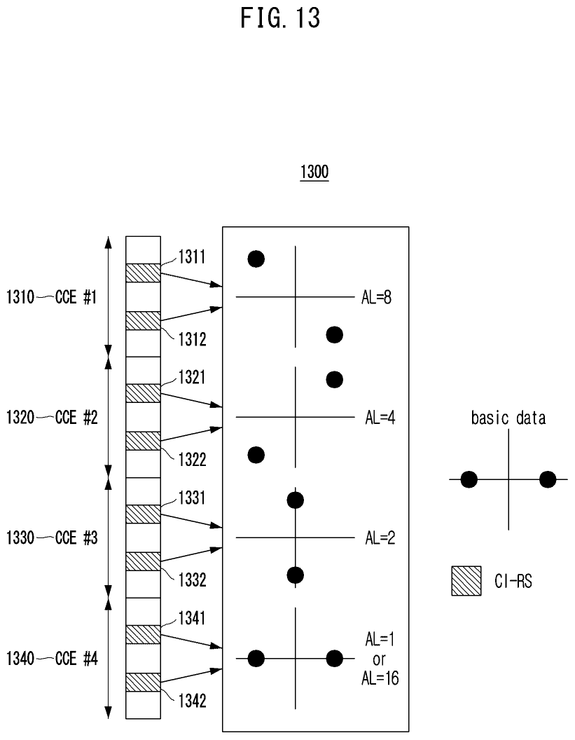

FIG. 13 is a conceptual diagram illustrating an exemplary embodiment of per-CCE AL information in the third configuration method for per-CCE AL information transmission according to an exemplary embodiment of the present disclosure.

Referring to FIG. 13, in the third configuration method for per-CCE AL information transmission according to an exemplary embodiment of the present disclosure, an exemplary embodiment 1300 of per-CCE AL information (hereinafter, an exemplary embodiment of third per-CCE AL information) may include multiple CCEs (i.e. CCE #1 1310, CCE #2 1320, CCE #3 1330, CCE #4 1340). The AL information of each of the multiple CCEs (i.e. CCE #1 1310, CCE #2 1320, CCE #3 1330, CCE #4 1340) may be represented using two CI-RSs. The AL information may indicate one of the values 1, 2, 4, or 8, and the AL information may be represented by adjusting a phase of basic data.

In the exemplary embodiment 1300 of third per-CCE AL information, the AL information value of the CCE #1 1310 may be 8 (AL=8), and the AL information value may be represented using the CI-RS #1 1311 and CI-RS #2 1312. The CI-RS #1 1311 may be represented as

$$- \frac{1}{\sqrt{2}} + j \frac{1}{\sqrt{2}} .$$

The CI-RS #2 1312 may be information obtained by rotating the CI-RS #1 1311 by 180 degrees. Additionally, when the AL information value of the CCE #1 1310 is 8, the AL information value 8 (i.e. AL 8) of the CCE #1 1310 may be a value obtained by rotating basic data 135 degrees clockwise.

In the exemplary embodiment 1300 of third per-CCE AL information, the AL information value of the CCE #2 1320 may be 4 (i.e. AL=4), and the AL information value may be represented using the CI-RS #3 1321 and CI-RS #4 1322. The CI-RS #3 1321 may be represented as

$$\frac{1}{\sqrt{2}} + j \frac{1}{\sqrt{2}} .$$

The CI-RS #4 1322 may be information obtained by rotating the CI-RS #3 1321 by 180 degrees. Additionally, when the AL information value of the CCE #2 1320 is 4, the AL information value 4 (i.e. AL 4) of the CCE #2 1320 may be a value obtained by rotating basic data 225 degrees clockwise.

In the exemplary embodiment 1300 of third per-CCE AL information, the AL information value of the CCE #4 1340 may be 1 (i.e. AL=1), and the AL information value may be represented using the CI-RS #7 1341 and CI-RS #8 1342. The CI-RS #7 1341 may be represented as 1. The CI-RS #8 1342 may be a value obtained by rotating the CI-RS #7 1341 by 180 degrees. Additionally, the AL information value 1 (i.e. AL 1) of the CCE #4 1330 may correspond to basic data. Additionally, when the AL information value 1 (i.e. AL 1) appears continuously 16 times, it may be determined as AL 16.

In the exemplary embodiment 1300 of third per-CCE AL information, the AL information value of the CCE #4 1340 may be 1 (i.e. AL=1), and the AL information value may be represented using the CI-RS #7 1341 and CI-RS #8 1342. The CI-RS #7 1341 may be represented as 1. The CI-RS #8 1342 may be a value obtained by rotating the CI-RS #7 1341 by 180 degrees. Additionally, the AL information value 1 (AL 1) of the CCE #4 1330 may correspond to basic data. Additionally, when the AL information value 1 (AL 1) appears continuously 16 times, it may be determined as AL 16.

For a USS, AL 1, AL 2, AL 4, and AL 8 may be supported. A receiving node (e.g. UE) may identify a phase from subcarrier(s) at a specific position within a CCE and determine an AL of the CCE. The receiving node may identify a resource size and position necessary for recovering control information based on the per-CCE AL information and perform decoding. When AL 16 is required, AL 16 may be determined as described above. In other words, when AL 1 is consecutively identified in 16 CCEs, the AL may be acquired as AL 16. The terminal may sequentially aggregate resources according to the per-CCE AL information and perform decoding based on the acquired AL value, similarly to the above-described first configuration method for per-CCE AL information transmission. Here, AL 1 may indicate a case where the AL information value is 1, AL 2 may indicate a case where the AL information value is 2, AL 4 may indicate a case where the AL information value is 4, and AL 8 may indicate a case where the AL information value is 8. Additionally, when the AL information value 1 (AL 1) appears continuously 16 times, it may be determined as AL 16.

When the size of subcarriers used for transmitting CCE AL information is denoted as K, first data c(k) for carrying AL information for a CCE may be generated using a random sequence. Second data d(k) may be obtained by performing BPSK modulation on the first data c(k). The second data d(k) may be multiplied by a phase adjustment value mᵢ corresponding to the AL and then allocated to subcarriers for transmission. When the phase adjustment value mᵢ for the second data d(k) is π/4, a reference signal transmitted through the subcarrier may be output by applying the phase adjustment value accordingly. The CI-RS may be expressed as shown in Equation 2.

$$CIRS = d ( k ) \cdot {m}_{i} , \qquad [ Equation 2 ]$$

$$k = 0 , 1 , … , K - 1$$

The phase adjustment value mᵢ corresponding to the AL may be represented as shown in Table 7.

TABLE 7

| AL | phase adjustment value (mᵢ) according to AL | |
|---|---|---|
| i | USS | CSS |
| 1 | 1 | — |
| 2 | j | — |
| 4 | $\frac{1}{\sqrt{2}} + j \frac{1}{\sqrt{2}}$ | $\frac{1}{\sqrt{2}} + j \frac{1}{\sqrt{2}}$ |
| 8 | $- \frac{1}{\sqrt{2}} + j \frac{1}{\sqrt{2}}$ | $- \frac{1}{\sqrt{2}} + j \frac{1}{\sqrt{2}}$ |
| 16 | — | 1 |

In Table 7, the AL information value may be one of 1, 2, 4, 8, or 16. For a USS, AL information values of 1, 2, 4, or 8 may be supported. For a CSS, AL information values of 4, 8, or 16 may be supported. When the AL information value is 1, the phase adjustment value mᵢ may be 0. When the AL information value is 2, the phase adjustment value mᵢ may be π/2. Additionally, when the AL information value is 4, the phase adjustment value mᵢ may be π/4, and when the AL information value is 8, the phase adjustment value mᵢ may be 3π/4.

When the USS region and the CSS region overlap within the CORESET, or when AL 16 is supported in the USS region, the receiving node (e.g. UE) may determine whether the AL is AL 1 or AL 16 and recover the information accordingly. When the USS region and the CSS region do not overlap within the CORESET and AL 16 is not supported in the USS, a representative value for the AL may be used as is. Here, AL 1 may indicate a case where the AL information value is 1, and AL 16 may indicate a case where AL 1 appears consecutively 16 times. The representative value for the AL may refer to the AL information value, and the AL information value may be one of 1, 2, 4, or 8, as described above.

The control information transmitted from the base station to the terminal may have a different resource position according to its purpose. When the control information needs to be received by all terminals within a service area supported by the control information, the control information may be formatted as a DCI format corresponding to its purpose in the CSS region, and after CRC addition, it may be masked with the corresponding RNTI before transmission. Examples of such information may include system information transmission, paging for initiating communication, response to PRACH transmission, uplink power control, slot format indication, and various other purposes. For uplink/downlink scheduling purpose for a specific terminal, control information may be transmitted through the USS region. If a new DCI format for notifying the per-CCE AL information of the control channel is referred to as 2_x, the new DCI format may be transmitted using the CSS region to ensure that the information is delivered to all terminals.

The terminal may attempt blind decoding of other control information based on the recovered per-CCE AL information verified through a C3I-RNTI in the CSS region. When the terminal acquires per-CCE AL information, the terminal may aggregate resources according to the CCE AL and perform recovery for single control information, similarly to the first configuration method.

To use resources more efficiently, a method for minimizing the decoding processing of the receiving node (e.g. UE) may be considered.

The receiving node (e.g. terminal) may perform a procedure to measure and report channel state information between the transmitting node (e.g. base station) and the receiving node (e.g. terminal). The receiving node may estimate and use an AL for its control information within a control channel transmitted by the transmitting node. The receiving node may refer to the reported channel state information and perform limited decoding using a candidate set associated with the channel state information instead of searching for all ALs. Additionally, the transmitting node (e.g. base station) may determine the CCE AL of the control channel to be transmitted based on the channel state information reported by the receiving node. Therefore, both the transmitting node and the receiving node may use the known channel state information to define a candidate CCE AL set and select a CCE AL within that set.

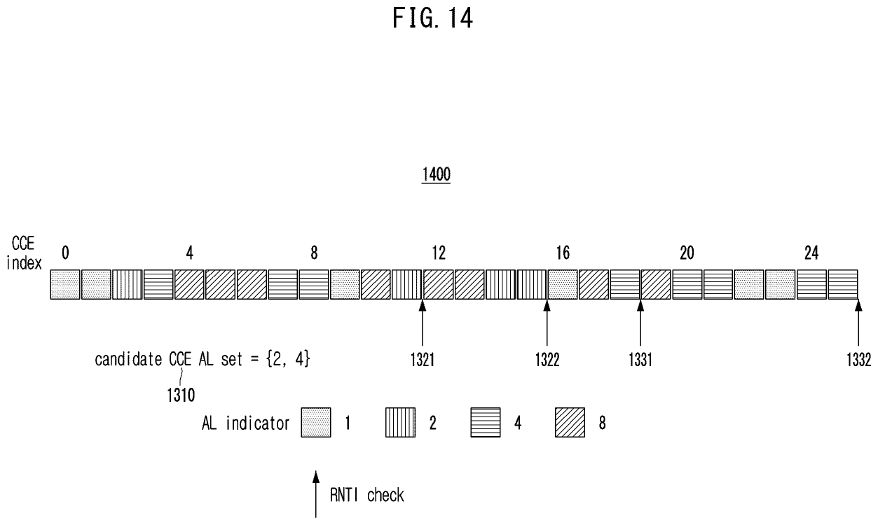

FIG. 14 is a conceptual diagram illustrating an exemplary embodiment of a first method for minimizing decoding processing according to an exemplary embodiment of the present disclosure.

Referring to FIG. 14, in an exemplary embodiment 1400 of a first method for minimizing decoding processing according to an exemplary embodiment of the present disclosure (hereinafter, an exemplary embodiment of the first method for minimizing decoding processing), the transmitting node may determine a CCE AL of a control channel based on channel state information reported by the receiving node. The receiving node may identify a candidate AL set 1310 based on the channel state information reported to the transmitting node. The candidate CCE AL set 1310 may include AL 2 and AL 4. The receiving node may perform decoding of control information by aggregating CCEs indexed as 2 and 11 using AL 2 from the candidate CCE AL set 1310. When the control information is successfully decoded, the receiving node may perform the RNTI check 1321 to determine whether the control information has been received. The receiving node may perform decoding of control information by aggregating CCEs indexed as 14 and using AL 2 from the candidate CCE AL set 1310. When the control information is successfully decoded, the receiving node may perform the RNTI check 1322 to determine whether the control information has been received. Additionally, the receiving node may perform decoding of control information by aggregating CCEs indexed as 3, 7, 8, and 18 using AL 4 from the candidate CCE AL set 1310. When the control information is successfully decoded, the receiving node may perform the RNTI check 1331 to determine whether the control information has been received. The receiving node may perform decoding of control information by aggregating CCEs indexed as 20, 21, 23, and 24 using AL 4 from the candidate CCE AL set 1310. When the control information is successfully decoded, the receiving node may perform the RNTI check 1332 to determine whether the control information has been received. It may be assumed that the per-CCE AL information is provided from the transmitting node to the receiving node. In FIG. 14, CCE indexes 0 to 25 are illustrated. However, this is merely for convenience of description and is not limited thereto.

In the communication system (e.g. 5G communication system or 6G communication system), when 64 quadrature amplitude modulation (QAM) is supported, channel state information may be classified into values ranging from 0 to 28 based on an MCS index table. The candidate CCE AL set for the UE-specific search space may be configured as shown in Table 8.

TABLE 8

| Channel state | |
|---|---|
| information | candidate CCE AL set |
| 28~14 | 1, 2 |
| 13~8 | 2, 4 |
| 7~0 | 4, 8 |

In Table 8, when the channel state information value is between 14 and 28, the candidate CCE AL set may include AL 1 and AL 2. When the channel state information value is between 8 and 13, the candidate CCE AL set may include AL 1 and AL 2. When the channel state information value is between 0 and 7, the candidate CCE AL set may include AL 4 and AL 8.

As illustrated in FIG. 14, when the candidate CCE AL set includes {2,4}, the receiving node may perform decoding for CCEs with AL 2 and AL 4. However, the recovery of control information in the CSS region may attempt full recovery using per-CCE AL information. Here, recovery attempts may refer to the decoding of control information.

Hereinafter, a second method (hereinafter, the second method) for minimizing the decoding processing in the receiving node to use resources more efficiently will be described.

In the second method for minimizing the decoding processing in the receiving node (e.g. UE), the position for allocating control information may be restricted to a specific section for each receiving node. The search area may be configured as a window of a fixed size starting from a position determined based on RNTI information of the receiving node. The receiving node may perform decoding of control information by utilizing CCE resources within the configured search area according to the CCE AL information.

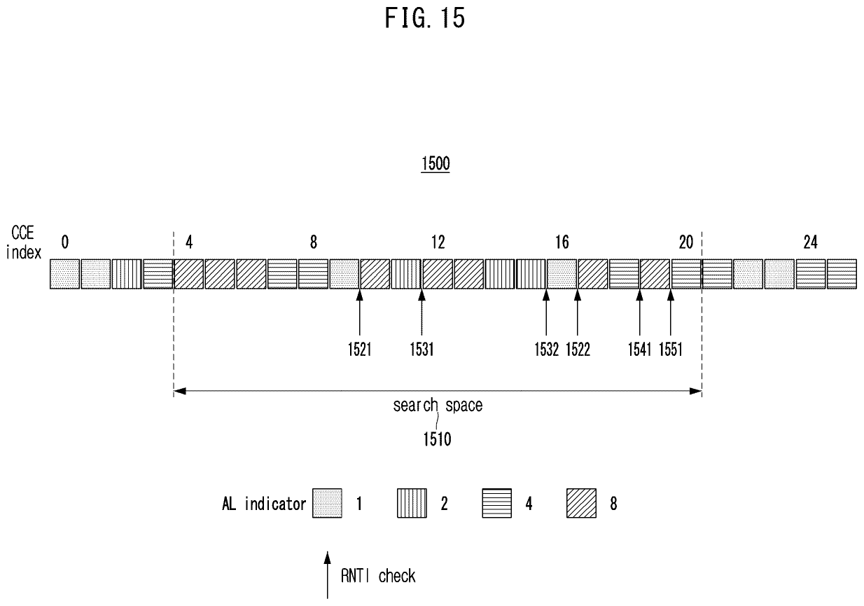

FIG. 15 is a conceptual diagram illustrating an exemplary embodiment of a second method for minimizing decoding processing according to an exemplary embodiment of the present disclosure.

Referring to FIG. 15, in an exemplary embodiment 1500 of the second method for minimizing decoding processing according to an exemplary embodiment of the present disclosure (hereinafter, an exemplary embodiment of the second method for minimizing decoding processing), a receiving node may perform multiple RNTI checks (e.g. RNTI check #1 1521, RNTI check #2 1522, RNTI check #3 1531, RNTI check #4 1532, RNTI check #5 1541, RNTI check #6 1551) performed within a configured search space 1510. When the AL indicator is 1, the receiving node may perform each of the RNTI checks (e.g. RNTI check #1 1521, RNTI check #2 1522) for a single CCE resource. The RNTI check #1 1521 may be performed after receiving a CCE corresponding to a CCE index 9. The RNTI check #2 1522 may be performed after receiving a CCE corresponding to a CCE index 16. The CCE corresponding to the CCE index 9 and the CCE corresponding to the CCE index 16 may each contain control information. When the AL indicator is 2, the receiving node may perform RNTI checks (e.g. RNTI check #3 1531, RNTI check #4 1532) after aggregating two CCEs. The RNTI check #3 1531 may be performed after aggregating two CCEs corresponding to CCE indexes 3 and 11. The RNTI check #4 1532 may be performed after aggregating two CCEs corresponding to CCE indexes 14 and 15. When the AL indicator is 4, the receiving node may aggregate four CCE resources and perform the RNTI check #5 1541. The RNTI check #5 1541 may be performed after aggregating the four CCEs corresponding to CCE indexes 3, 7, 8, and 18. When the AL indicator is 8, the receiving node may aggregate eight CCEs and perform the RNTI check #6 1551. The RNTI check #6 1551 may be performed after aggregating the eight CCEs corresponding to CCE indexes 4, 5, 6, 10, 12, 13, 17, and 19.

Hereinafter, an exemplary embodiment of a configuration procedure for transmitting per-CCE AL information according to the present disclosure (hereinafter, an exemplary embodiment of the per-CCE AL information configuration procedure) will be described.

In the exemplary embodiment of the per-CCE AL information configuration procedure, a communication system may include a first communication node and a second communication node and may perform the following steps. Here, the first communication node may be a UE, and the second communication node may be a base station. Additionally, the first communication node and the second communication node may be configured identically or similarly to the communication nodes illustrated in FIG. 2.

In step S610, the second communication node may transmit per-CCE AL information to the first communication node.

In step S1610, the first communication node may obtain the per-CCE AL information from the second communication node. Here, the per-CCE AL information may include AL information for each of a plurality of CCEs, and the AL information may indicate a CCE AL. The AL information may be included in the per-CCE AL information in ascending order of CCE indexes.

In an exemplary embodiment, it may be assumed that the per-CCE AL information is configured using the first configuration method described above.

In an exemplary embodiment, the second communication node (e.g. base station) may transmit the per-CCE AL information to the first communication node (e.g. terminal) through a first channel based on first channel configuration information. The first communication node may obtain the per-CCE AL information by receiving the first channel from the second communication node based on the first channel configuration information. The first channel configuration information may include information indicating control channel resources used by the first channel. The first communication node may receive the first channel configuration information from the second communication node. Alternatively, the first communication node may use predefined information as the first channel configuration information. The first channel may refer to a physical control aggregation level information indicator channel (PCAICH), and the first channel may transmit the per-CCE AL information as shown in FIG. 9. In FIG. 9, the PCAICH data may indicate the per-CCE AL information.

In another exemplary embodiment, it may be assumed that the per-CCE AL information is configured using the second configuration method described above.

In another exemplary embodiment, the second communication node may transmit first downlink control information (DCI) including the per-CCE AL information to the first communication node. The first communication node may obtain the per-CCE AL information by receiving the first DCI including the per-CCE AL information. The first DCI may be searched in a CSS. Here, the first DCI may be scrambled with an RNTI as shown in FIG. 3. The RNTI may be a control channel CCE information RNTI (C3I-RNTI). The C3I-RNTI may be used in the CSS, as shown in Table 6.

In another exemplary embodiment, the first communication node may further perform a step of receiving the RNTI from the second communication node. The step of receiving the RNTI may be performed before step S1610. In other words, at a first time, the first communication node may receive information on the C3I-RNTI for identifying the first DCI, and at a second time, the first communication node may receive the first DCI including the per-CCE AL information. The first time may precede the second time.

In yet another exemplary embodiment, it may be assumed that the per-CCE AL information is configured using the third configuration method described above.

In yet another exemplary embodiment, as described above, the per-CCE AL information may include AL information for each of a plurality of CCEs, and the AL information may be identified based on phase information of each of a plurality of subcarriers within a CCE. In other words, the first communication node may obtain the per-CCE AL information by identifying the AL information based on the phase information of each of a plurality of predefined subcarriers within each of the plurality of CCEs.

In step S1620, the second communication node may generate control information to be transmitted to the first communication node. The second communication node may transmit the control information generated based on the per-CCE AL information to the first communication node.

In step S1620, the first communication node may determine whether the control information received from the second communication node is received based on the per-CCE AL information acquired in step S1610.

In step S1630, when the reception of the control information is confirmed, the first communication node may obtain the control information.

The control information may refer to DCI, and in the resources for the control channel, a CCE may be used as a basic unit for DCI. A single DCI may be transmitted by allocating 1, 2, 4, or 8 CCEs as needed.

The per-CCE AL information may include AL information for each of a plurality of CCEs, and the AL information for each CCE may indicate aggregation (or combination) level of each CCE. Additionally, the AL information for each CCE may be included in the per-CCE AL information in ascending order of CCE indexes. Here, the CCE may refer to a CCE resource.

The AL information for each CCE may indicate one of the values 1, 2, 4, or 8. As described above, when the AL information for each CCE indicates 1 (AL=1), a single CCE resource may be allocated and used for one DCI transmission. When the AL information for each CCE indicates 2 (AL=2), two CCEs may be allocated and used for DCI transmission. When the AL information for each CCE indicates 4 (AL=4), four CCEs may be allocated and used for DCI transmission. When the AL information for each CCE indicates 8 (AL=8), eight CCEs may be allocated and used for DCI transmission. Additionally, when 16 consecutive per-CCE AL information values indicate 1, 16 CCEs may be allocated and used for DCI transmission.

In an exemplary embodiment, the control information may be transmitted using a single CCE or two or more CCEs having consecutive identical AL information within the per-CCE AL information.

In an exemplary embodiment, the per-CCE AL information may be configured as shown in FIG. 10.

In another exemplary embodiment, the control information may be transmitted using a single CCE or two or more CCEs having consecutive identical AL information within the per-CCE AL information. In other words, the control information may be transmitted using a single CCE, two or more CCEs having consecutive identical AL information, or two or more CCEs having non-consecutive identical AL information within the per-CCE AL information.

In another exemplary embodiment, the per-CCE AL information may be configured as illustrated in FIG. 11.

In the communication system (e.g. 5G communication system or 6G communication system), as shown in Equation 1, the control information recovery candidate position may have continuous resource arrangement according to CCE AL values based on a starting point and may be scheduled so as not to overlap with other terminal's information allocation resources. The terminal may perform blind decoding in all possible candidate regions according to AL without its own AL information, depending on the supported DCI format types.

Although control information transmission may be scheduled and allocated within control channel resources by aggregating transmission resources according to AL, the number of decoding attempts may be limited considering hardware complexity. This limitation may be considered during scheduling to determine the possible candidate resource locations. Accordingly, resource allocation without an AL size variable may enable more flexible resource allocation when scheduling control channels for multiple terminals.

According to the present disclosure, the receiving node may be provided with per-CCE AL information from the transmitting node and may utilize CCEs for control information regardless of the allocation of specific positions according to AL. When the resource region of the control channel is large enough for a single receiving node to attempt decoding for all CCEs, all CCEs may be utilized without determining starting points. Considering the number of PDCCH candidates for limited decoding attempts, a candidate CCE AL set may be defined, or a certain window size from a starting point

$${Y}_{p , {n}_{s , f}^{μ}}$$

the CCE for recovering the receiving node's control information may be regarded as the search area of the receiving node. When the AL applied to the receiving node's decoding is limited and the resource region is also restricted, the receiving node may perform decoding for its control channel information with a small number of blind decoding attempts.

According to the present disclosure, a configuration may be included in which per-CCE AL information, which is information on transmission resources for decoding control information, is transmitted, and CCEs are allocated for transmitting control information according to AL. Additionally, when transmitting per-CCE AL information, the utilized resources may include assigning a specific channel for transmitting per-CCE AL information, using a DCI format, or transmitting through reference signal(s).

For a backhaul link utilizing a wide bandwidth of an extremely high frequency band, a subcarrier spacing in OFDM may vary more than in conventional communication systems (e.g. 5G communication system or 6G communication system) depending on the frequency band characteristics. Additionally, the channel environment may vary for each terminal, and a large number of terminals may be scheduled. By transmitting per-CCE AL information to enable a flexible configuration of the control channel, an approach is proposed to improve reception complexity and scheduling flexibility. This configuration may also be applied to communication systems for transmitting control channel and other channel information beyond backhaul systems.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first communication node, comprising:
obtaining control channel element (CCE) aggregation level (AL) information from a second communication node;
identifying whether control information is received from the second communication node based on the CCE AL information; and
in response to identifying that the control information is received, obtaining the control information,
wherein the CCE AL information includes AL information of each of a plurality of CCEs, the AL information indicates a CCE AL, and the AL information is included in the CCE AL information in ascending order of CCE indexes.

2. The method according to claim 1, wherein the first communication node performs decoding of the control information using one CCE or two or more CCEs having same AL information consecutively within the CCE AL information.

3. The method according to claim 1, wherein the first communication node performs decoding of the control information using one CCE, two or more CCEs having same AL information consecutively within the CCE AL information, or two or more CCEs having same AL information non-consecutively within the CCE AL information.

4. The method according to claim 1, wherein the CCE AL information is received from the second communication node through a first channel based on first channel configuration information, the first channel configuration information includes information indicating a control channel resource used by the first channel, and the first channel configuration information is information received from the second communication node or predefined information.

5. The method according to claim 1, wherein the first communication node receives first downlink control information (DCI) including the CCE AL information from the second communication node, and the first DCI is searched in a common search space (CSS).

6. The method according to claim 5, wherein the first communication node receives information on a first radio network temporary identifier for identifying the first DCI at a first time from the second communication node, the first communication node receives the CCE AL information from the second communication node at a second time, and the first time is a time before the second time.

7. The method according to claim 1, wherein the AL information is identified based on information on a phase of each of preconfigured multiple subcarriers.

8. A method of a second communication node, comprising:
transmitting control channel element (CCE) aggregation level (AL) information to a first communication node;
generating control information to be transmitted to the first communication node; and
transmitting the control information to the first communication node based on the CCE AL information,
wherein the CCE AL information includes AL information of each of a plurality of CCEs, the AL information indicates a CCE AL, and the AL information is included in the CCE AL information in ascending order of CCE indexes.

9. The method according to claim 8, wherein the second communication node transmits the control information to the first communication node using one CCE or two or more CCEs having same AL information consecutively within the CCE AL information.

10. The method according to claim 8, wherein the second communication node transmits the control information to the first communication node using one CCE, two or more CCEs having same AL information consecutively within the CCE AL information, or two or more CCEs having same AL information non-consecutively within the CCE AL information.

11. The method according to claim 8, wherein the CCE AL information is transmitted to the first communication node through a first channel based on first channel configuration information, the first channel configuration information includes information indicating a control channel resource used by the first channel, and the first channel configuration information is information transmitted to the first communication node or predefined information.

12. The method according to claim 8, wherein the second communication node transmits first downlink control information (DCI) including the CCE AL information to the first communication node, and the first DCI is searched in a common search space (CSS).

13. The method according to claim 12, wherein the second communication node transmits information on a first radio network temporary identifier (RNTI) for identifying the first DCI to the first communication node at a first time, the second communication node transmits the CCE AL information to the first communication node at a second time, and the first time is a time before the second time.

14. The method according to claim 8, wherein the AL information is identified based on information on a phase of each of preconfigured multiple subcarriers.

15. A first communication node comprising at least one processor, wherein the at least one processor causes the first communication node to perform:
obtaining control channel element (CCE) aggregation level (AL) information from a second communication node;
identifying whether control information is received from the second communication node based on the CCE AL information; and
in response to identifying that the control information is received, obtaining the control information,
wherein the CCE AL information includes AL information of each of a plurality of CCEs, the AL information indicates a CCE AL, and the AL information is included in the CCE AL information in ascending order of CCE indexes.

16. The first communication node according to claim 15, wherein the first communication node performs decoding of the control information using one CCE or two or more CCEs having same AL information consecutively within the CCE AL information.

17. The first communication node according to claim 15, wherein the first communication node performs decoding of the control information using one CCE, two or more CCEs having same AL information consecutively within the CCE AL information, or two or more CCEs having same AL information non-consecutively within the CCE AL information.

18. The first communication node according to claim 15, wherein the CCE AL information is received from the second communication node through a first channel based on first channel configuration information, the first channel configuration information includes information indicating a control channel resource used by the first channel, and the first channel configuration information is information received from the second communication node or predefined information.

19. The first communication node according to claim 15, wherein the first communication node receives first downlink control information (DCI) including the CCE AL information from the second communication node, and the first DCI is searched in a common search space (CSS).

20. The first communication node according to claim 19, wherein the first communication node receives information on a first radio network temporary identifier for identifying the first DCI at a first time from the second communication node, the first communication node receives the CCE AL information from the second communication node at a second time, and the first time is a time before the second time.
